(19) United States
(12) Patent Application Publication
(10) Pub. No.: US 2026/0349190 A1
(43) Pub. Date: Nov. 5, 2026

(54) MODULAR GANGED CONNECTOR ASSEMBLIES WITH INTEGRATED COUPLING, LATCHING, ALIGNMENT, CABLE MANAGEMENT, AND DUST PROTECTION ELEMENTS

(71) Applicant: Leviton Manufacturing Co., Inc., Melville, NY (US)

(72) Inventors: Charles Bragg, Bothell, WA (US); Jon Clark Riley, Redmond, WA (US)

(21) Appl. No.: 19/161,105

(22) PCT Filed: Jul. 11, 2025
(86) PCT No.: PCT/US2025/037336

§ 371 Date: Aug. 29, 2025

Related U.S. Application Data
(60) Provisional application No. 63/673,342, filed on Jul. 19, 2024.
(60) Provisional application No. 63/788,708, filed on Apr. 14, 2025.
(60) Provisional application No. 63/802,364, filed on May 8, 2025.

(51) Int. Cl. G02B 6/38; G02B 6/40; G02B 6/44; H01R 13/518; H01R 13/52; H01R 13/62; H01R 13/621; H01R 13/74

(52) U.S. Cl. CPC G02B 6/3894; G02B 6/3849; G02B 6/3886; G02B 6/3897; G02B 6/406; G02B 6/44526; H01R 13/518; H01R 13/5213; H01R 13/6205; H01R 13/621; H01R 13/745; H01R 2201/04

(57) ABSTRACT

A ganged connector system facilitates high-density cabling installations in datacenter environments. The system can include modular ganged connector assemblies having alignment features, a magnetically assisted detent, and a push screw coupling mechanism. The alignment features can facilitate pre-alignment between mating connectors, and the magnetic detent can provide temporary retention prior to final engagement. A threaded push screw assembly can apply a coupling force via mechanical advantage, enabling a single installer to achieve full connector mating. Patch panel assemblies can retain front-and rear-side ganged connector modules using cantilevered snap-fit brackets and can support drawer slide mechanisms for improved access. Additional elements can include removable dust caps for protecting connector end faces and internal cable management spools for maintaining bend radii of optical fibers within the housing. Taken together, these features can simplify installation, improve alignment accuracy, reduce contamination risk, and support modular servicing of ganged connectors in data communication systems.

### RELATED APPLICATIONS

This application claims priority to each of U.S. Provisional Patent Application No. 63/802,364, filed on May 8, 2025, and entitled “LATCHING MECHANISM FOR PATCH PANEL ASSEMBLIES”, U.S. Provisional Patent Application No. 63/788,708, filed on Apr. 14, 2025, and entitled “GANGED CONNECTORS THAT FACILITATE SIMPLIFIED INSTALLATION”, and U.S. Provisional Patent Application No. 63/673,342, filed on Jul. 19, 2024, and entitled “PUSH SCREW ASSEMBLIES THAT COUPLE AND SECURE GANGED CONNECTORS”, the entireties of which priority applications are incorporated by reference herein.

### TECHNICAL FIELD

The disclosed subject matter relates generally to connector systems for data communication equipment, and for example, to modular ganged connector assemblies that can facilitate alignment, coupling, latching, and strain relief for high-density cabling systems, such as fiber optic and copper cabling, in data center environments. The disclosed subject matter further relates to associated elements including simplified removal of specialized dust caps that protect connector end faces and internal spool structures for managing optical fiber routing within the connector housing.

### BACKGROUND

Connector systems are commonly employed to transmit data signals in networked communication environments. In such systems, it can be desirable to organize multiple individual connectors into a common housing, a practice referred to as ganging. Ganged connectors can provide improved density and ease of installation by enabling simultaneous coupling of multiple signal paths.

Data communication systems, such as those used in data centers, can include patch panels or cabinet assemblies configured to house ganged connector assemblies. These patch panels can feature apertures that receive the ganged connector assemblies from a front side or a rear side of the panel.

To protect the connector end faces during transport and handling, removable dust caps can be used. Internal cable routing structures within the ganged connector assemblies can organize fiber optic or copper cabling and maintain minimum bend radii as required for optical performance.

Various connector arrangements and patch panel architectures have been proposed for use in such environments, including features that promote organized cable management and facilitate the mating of multiple connector elements within a shared housing.

### SUMMARY

The following presents a simplified summary of the disclosed subject matter in order to provide a basic understanding of some aspects of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

Various embodiments described herein provide a connector apparatus comprising a housing. The housing can comprise a group of connectors that are individually configured to couple to a corresponding member of a corresponding ganged connector apparatus.

The connector apparatus can further comprise a push screw receiver. The push screw receiver can be configured to facilitate attaching and securing of the ganged connector apparatus to the corresponding ganged connector apparatus in response to receiving a threaded section of a push screw, of the corresponding ganged connector apparatus, in a direction substantially along a screw axis of the push screw.

The push screw receiver can comprise a threaded receiver and a receiver pivot. The threaded receiver can comprise receiver threads configured to mate with screw threads of the threaded section of the push screw. The receiver pivot can, e.g., in response to an axial force applied in the direction by the screw threads in contact with the receiver threads, facilitate rotation of the threaded receiver about a pivot axis. The pivot axis can be substantially perpendicular to the screw axis. The receiver pivot can further be configured to transition, via the rotation, to an open state in which the threaded receiver is rotated sufficiently to allow the screw threads to clear the receiver threads in response to the axial force applied in the direction.

Other embodiments described herein provide a connector apparatus comprising a housing. The housing can comprise a group of connectors that are individually configured to couple to a corresponding member of a corresponding ganged connector apparatus.

The connector apparatus can further comprise a push screw. The push screw can be configured to facilitate attaching and securing of the ganged connector apparatus to the corresponding ganged connector apparatus. The push screw can comprise a head section that is exposed on a head side of the housing, a shank section that extends through the housing in an axial direction, and a thread section that extends in the axial direction and is exposed on an interface side of the housing that is opposite the head side.

The thread section can comprise screw threads configured to mate with receiver threads of a threaded receiver of the corresponding ganged connector apparatus. A first portion of the screw threads are configured to clear a second portion of the receiver threads in response to an axial force applied substantially in the axial direction. Such can result in the thread section being axially seated in the threaded receiver after application of the axial force.

The connector apparatus can further comprise a crank device. The crank device can be configured to rotate the push screw when the thread section is axially seated in the threaded receiver.

The present disclosure further relates to patch panel architectures for high-density data cabling systems, and more specifically to a patch panel assembly configured to receive and retain front-and rear-insertable ganged connector modules using laterally-positioned bracket structures.

In one aspect, the disclosed subject matter provides a patch panel retention insert that can be mounted to a lateral side of a patch panel aperture. The insert comprises a first cantilevered tab and a second cantilevered tab, where the first cantilevered tab can be configured to engage and retain a first ganged connector module inserted from the front side of the patch panel, and the second cantilevered tab can be configured to engage and retain a second ganged connector module inserted from the rear side. Each cantilevered tab can comprise a snap-fit mechanism, such as a protrusion or recess, that locks into place upon suitable seating of the associated ganged connector module. The cantilevered tabs may also be configured to release in response to a lateral force, thereby enabling tool-less or partially tool-less installation and removal.

In another aspect, a patch panel assembly is provided comprising an aperture configured to receive the front and rear ganged connector modules along an axial direction, and a pair of dual ganged connector brackets situated on opposing lateral sides of the aperture. Each bracket can include two cantilevered tabs, one for each of the front and rear connector modules. Together, the bracket pair can operate to retain both ganged connector modules in alignment for mating engagement.

In some embodiments, the patch panel assembly can be mounted on a drawer slide mechanism that allows the assembly to extend outward from a data cabinet to facilitate installation or servicing. A rear beam structure may be coupled to the drawer slide to support the weight of trunk cabling connected to the rear ganged connector module, thereby reducing shear forces at the connector interface and improving strain relief.

A corresponding method of use is also provided, comprising the steps of inserting the ganged connector modules into the patch panel from respective sides until they are retained by the dual ganged connector brackets, and operating the patch panel assembly in a coupled state within a data communication system. Optional steps may include unlatching either ganged connector by actuating a cantilevered tab and extending the drawer slide to access the connectors.

Various embodiments of the present disclosure relate to a multi-faceted ganged connector system that improves installation, alignment, securement and dust protection for high-density data cabling, e.g., fiber optic cabling. In one aspect, a magnet detent device can be employed to provide early-stage retention between mating ganged connectors. The magnet can allow the connectors to be held together with minimal force before final compression is applied, enabling simpler blind installation in tight or deep cabinets.

Various alignment features can be included in the ganged connectors to facilitate precise coupling of large multi-fiber connector arrays. For example, a T-member (or similar protruding key) can register with a slotted tray to guide a ganged connector and attached trunk cable into place from the rear of a deep cabinet. As another example, a variety of alignment structures or geometries can be included with the ganged connectors, such as wings or “ears” that can mate with associated recesses to provide pre-alignment and/or coarse alignment. As another example alignment element, a tenon element of one ganged connector can mate with a corresponding mortise element of another ganged connector to guide the connectors prior to applying a compression force. The tenon element and the mortise element can also serve as respective housings for a threaded bolt and threaded nut that can be used to apply the compression force. One or more spring devices can bias components (e.g., a magnet or threaded nut) in a forward direction to ensure reliable contact before full tightening.

In another aspect, the ganged connector system can employ a drawer slide mechanism to extend the connector assembly forward. This can allow an installer to feed a trunk cable along with the ganged connector from the cabinet's rear to its front, and then pull the connector forward via the slide for final attachment, all without requiring a second person to assist.

Further, a dust cap solution is disclosed that leverages individually attachable dust caps for each connector in a high-density ganged assembly. These caps can be snapped onto a carrier tool that permits a single-motion removal of all caps at once, thereby reducing installation time and also reducing the time that factory cleaned connector tips remain exposed to airborne contaminants.

Taken individually or in combination, the disclosed subject matter can overcome several problems posed by large-scale ganged connectors in cramped or deep-enclosure environments, potentially reducing labor effort, risk of contamination, and complexity of installation. The disclosed subject matter can further simplify installation, reduce service downtime, improve mechanical alignment, and enable independent front-and rear-side access to high-density ganged connectors while reducing tool requirements or disassembly of the patch panel as well as provide force amplification for mating two ganged connector assemblies.

### BRIEF DESCRIPTION OF THE DRAWINGS

Numerous aspects, embodiments, objects, and advantages of the present embodiments will be apparent upon consideration of the following detailed description, taken in conjunction with the accompanying drawings, in which like reference characters refer to like parts throughout, and in which:

FIG. 1 shows a first example isometric side view of an example ganged connector apparatus (GCA) that is configured to mate with a corresponding ganged connector apparatus (CGCA) in accordance with example embodiments of this disclosure;

FIG. 2 shows a second example isometric side view of the example GCA in accordance with example embodiments of this disclosure;

FIG. 3 shows a first example isometric side view of an example CGCA that can be configured to mate with the GCA in accordance with example embodiments of this disclosure;

FIG. 4 shows a second example isometric side view of the example CGCA in accordance with example embodiments of this disclosure;

FIG. 5 depicts an example isometric view of an example push screw assembly, in an example first state, that facilitates attaching and securing the GCA to the CGCA in accordance with example embodiments of this disclosure;

FIG. 6 depicts an example isometric view of the example push screw assembly, in an example second state, that facilitates attaching and securing the GCA to the CGCA in accordance with example embodiments of this disclosure;

FIG. 7 illustrates an example isometric view of the example push screw assembly, in an example third state, that facilitates attaching and securing the GCA to the CGCA in accordance with example embodiments of this disclosure;

FIG. 8 illustrates a first example orthogonal cross section view of the example push screw assembly in the example second state in accordance with example embodiments of this disclosure;

FIG. 9 illustrates a second example orthogonal cross section view of the example push screw assembly in the example third state in accordance with example embodiments of this disclosure;

FIG. 10 shows an example isometric view of a second example GCA that is configured to mate with a second example of a corresponding CGCA in accordance with various embodiments of this disclosure;

FIG. 11 shows an example isometric view of the second example CGCA that can be configured to mate with the second example GCA in accordance with various embodiments of this disclosure;

FIG. 12 shows an example isometric view of an example of pre-alignment depicting a scenario in which the GCA is moved into proximity with the CGCA in accordance with various embodiments of this disclosure;

FIG. 13 shows an example isometric view of example connectors, such as Small Form Factor (“SFF”) or Very Small Form Factor (“VSFF”) connectors e.g. MMC connectors, at or just prior to the aligned state in accordance with various embodiments of this disclosure;

FIG. 14 depicts an example isometric view of the ganged connectors according to another example of the aligned state in accordance with various embodiments of this disclosure;

FIG. 15 depicts an example isometric view of an example cabinet tray with the GCA installed in the slotted tray in accordance with various embodiments of this disclosure;

FIG. 16 illustrates an example isometric view of a bottom side of a ganged connector showing at least one T-member in accordance with various embodiments of this disclosure;

FIG. 17 illustrates an example isometric view of a bottom side of a ganged connector showing at least one T-member in accordance with various embodiments of this disclosure;

FIG. 18 illustrates an example isometric view of the ganged connectors illustrating protrusion of the magnet prior to the aligned state in accordance with various embodiments of this disclosure;

FIG. 19 illustrates an example lateral cross section of the GCA depicting an internal view that shows an example spring device to bias the magnet and/or the threaded nut in accordance with various embodiments of this disclosure;

FIG. 20 illustrates an example isometric view of the two ganged connectors in the aligned state and ready for application of the compression force via a tool in accordance with various embodiments of this disclosure;

FIG. 21 illustrates an example longitudinal cross section of the GCA depicting an internal view that shows the ganged connectors prior to the aligned state in accordance with various embodiments of this disclosure;

FIG. 22 illustrates an example longitudinal cross section of the GCA depicting an internal view that shows the ganged connectors in an aligned state with magnets coupled and prior to application of the compression force in accordance with various embodiments of this disclosure;

FIG. 23 illustrates an example longitudinal cross section of the GCA depicting an internal view that shows the ganged connectors after application of the compression force in accordance with various embodiments of this disclosure;

FIG. 24 illustrates an example isometric view of an example multiple dust cap removal tool and associated specialized dust caps in accordance with various embodiments of this disclosure;

FIG. 25 illustrates a first example isometric view of the example multiple dust cap removal tool in operation just prior to engaging with the dust caps in accordance with various embodiments of this disclosure;

FIG. 26 illustrates a second example isometric view of the example multiple dust cap removal tool in operation just after engaging with the dust caps causing the dust caps to deform to allow transition of the detents in accordance with various embodiments of this disclosure;

FIG. 27 illustrates an isometric side and top view on an individual dust cap showing advantageous geometry in accordance with various embodiments of this disclosure;

FIG. 28 illustrates an example isometric view of an example drawer slide that can facilitate sliding the GCA beyond the frame of the cabinet in accordance with various embodiments of this disclosure; and

FIG. 29 illustrates an example isometric view of an example drawer slide that can facilitate targeted workspace for an installer in accordance with various embodiments of this disclosure;

FIG. 30 depicts first isometric view of an example patch panel assembly comprising a latching mechanism that facilitates retaining or releasing either one or both interfaced ganged connectors in accordance with various embodiments of this disclosure;

FIG. 31 depicts a second isometric view of the example patch panel assembly comprising the latching mechanism that facilitates retaining or releasing either one or both interfaced ganged connectors in accordance with various embodiments of this disclosure;

FIG. 32 depicts an orthographic side view of an example patch panel retention insert configured to be inserted into a patch panel frame to provide the GC bracket functionality in accordance with various embodiments of this disclosure;

FIGS. 33A and 33B depict different isometric views of the example patch panel retention insert that is configured to be inserted into a patch panel frame to provide latching or unlatching of GC modules in accordance with various embodiments of this disclosure;

FIGS. 34A and 34B depict respective isometric views showing two distinct states of the second cantilevered tab of the GC bracket as the rear GC module transitions to the locked or latched state in accordance with various embodiments of this disclosure;

FIGS. 35A and 35B depict respective isometric views showing two distinct states of the first cantilevered tab of the GC bracket as the front GC module transitions to the locked or latched state in accordance with various embodiments of this disclosure;

FIG. 36 depicts an example flow diagram representing a process for insertion and retention of GC modules with respect to a patch panel assembly in accordance with various embodiments of this disclosure;

FIG. 37 depicts an example flow diagram representing additional aspects or elements of the process for insertion and retention of GC modules with respect to a patch panel assembly in accordance with various embodiments of this disclosure; and

FIG. 38 depicts an exploded isometric view of the rear GC module, showing a spool configured for internal cable routing in accordance with various embodiments of this disclosure.

### DETAILED DESCRIPTION

### First Example Ganged Connector Mating Pair

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

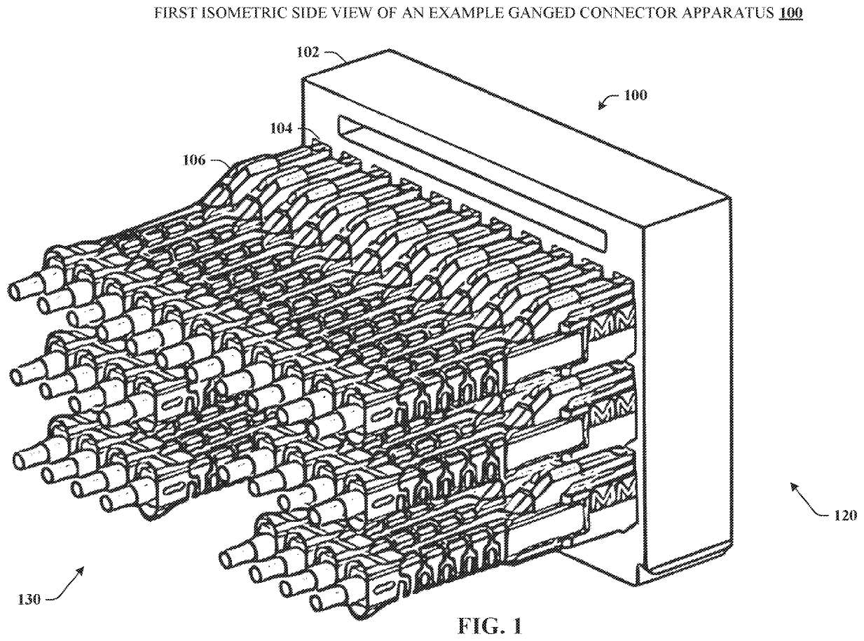

To provide additional context, consider FIGS. 1-4, which depict various perspectives of an example ganged connector apparatus (GCA) 100 and an example corresponding ganged connector apparatus (CGCA) 300. GCA 100 is configured to mate with GCA 300 and therefore, by convention, one may be referred to as a male type ganged connector with the other being referred to as a female type ganged connector. However, it is appreciated that the disclosed elements or techniques can be implemented according to a different convention. For example, elements or aspect detailed herein in connection with GCA 100 may instead be associated with CGCA 300 and vice versa.

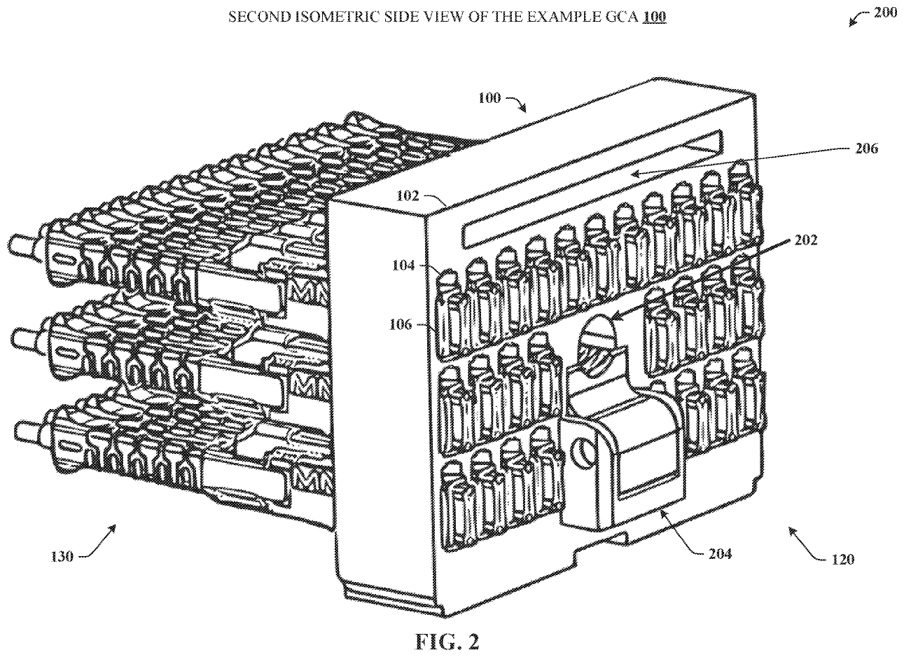

FIG. 1 shows a first example isometric side view of an example GCA 100 that can be configured to mate with a CGCA 300 in accordance with example embodiments of this disclosure. The first example isometric view is from a back side 130 perspective (also referred to herein as a conduit side). FIG. 2 shows a second example isometric side view 200 of the example GCA 100 in accordance with example embodiments of this disclosure. The second example isometric view 200 is from an interface side 120 perspective (also referred to herein as a front side).

As illustrated, GCA 100 can comprise housing 102. Housing 102 can comprise a group or array of openings 104 that are configured to receive connectors 106. Thus, when deployed, all or a portion of openings 104 can be fitted with connectors 106, as shown. As a representative, though non-limiting example, connectors 106 can be fiber optic ferrules that are configured or compliant with any suitable connector type or form factor, including, for example, a miniature multi-channel (MMC) connector, a multi-fiber push on (MPO) connector, a multi-fiber termination push-on (MTP) connector, or another suitable type of connection interface. In the present example, and as used as a non-limiting example herein, connector 106 is an MMC connector. Other connector types are contemplated including copper-type connectors such as an RJ45 connector, or another suitable type of connector, including fiber optic type connectors, copper type connectors, and beyond.

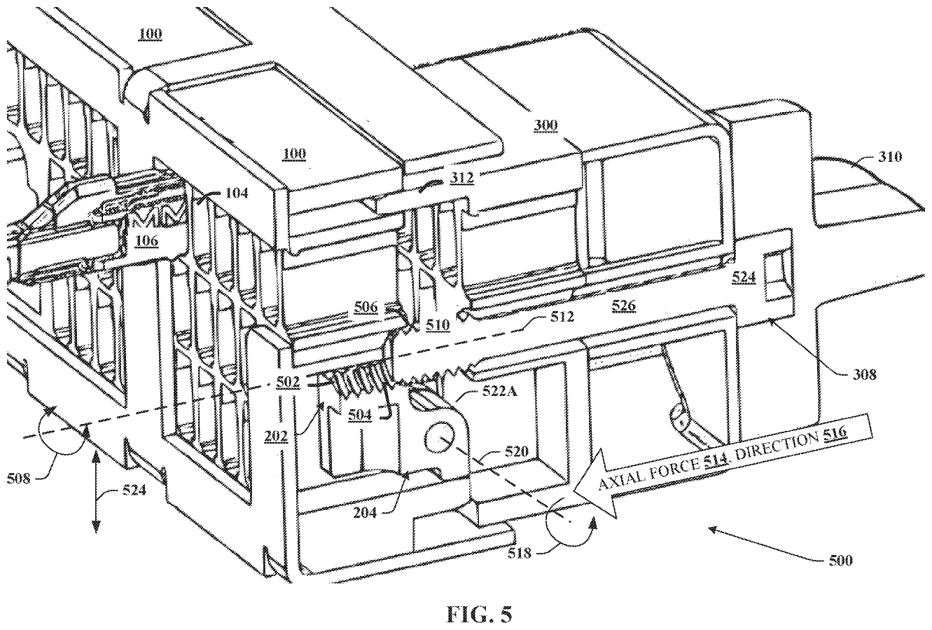

GCA 100 can further comprise push screw receiver 202 and receiver pivot 204, which are further detailed in connection with FIG. 5 and subsequent drawings herein.

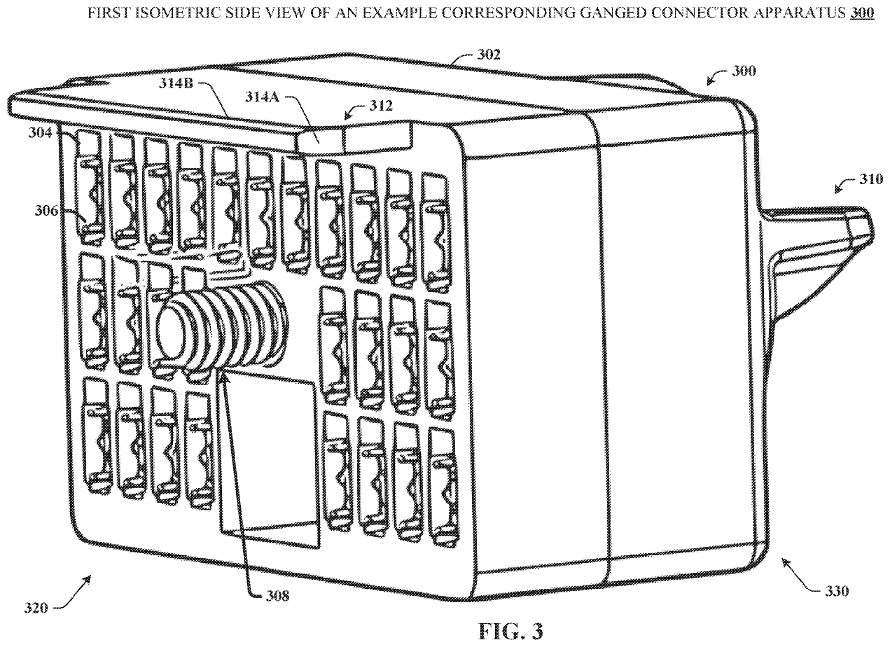

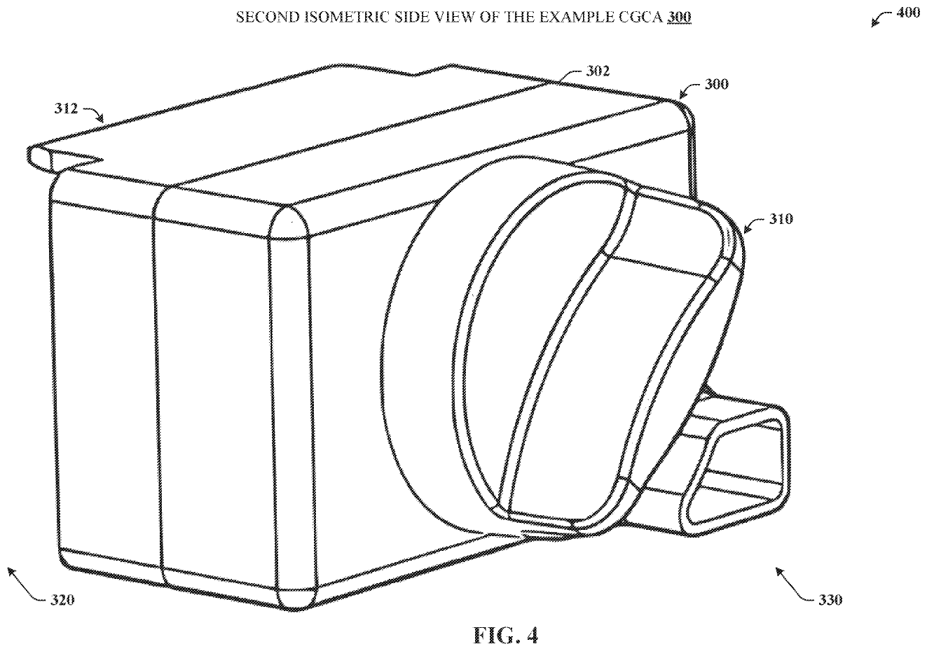

FIG. 3 shows a first example isometric side view of an example CGCA 300 that can be configured to mate with the GCA 100 in accordance with example embodiments of this disclosure. The first example isometric view is from an interface side 320 perspective (also referred to herein as a front side). FIG. 4 shows a second example isometric side view 400 of the example CGCA 300 in accordance with example embodiments of this disclosure. The second example isometric view 400 is from an interface side 330 perspective (also referred to herein as head side or crank side). In that regard, as used herein, the interface side 120, 320, represents the side of the associated apparatus (e.g., GCA 100 or CGCA 300) that interfaces to the other. Sides 130, 330 represent the opposing side that is opposite relative to some axis (e.g., screw axis 512) that will be detailed further below.

CGCA 300 can comprise openings 304 configured to house or seat corresponding connectors 306. Thus, openings 304 can be aligned with openings 104 of GCA 100 so that corresponding connectors 306 can be mated to connectors 106 of GCA 100.

In these examples, there are 27 individual connectors 106 that are ganged together by GCA 100 and a like number of corresponding connectors 306 ganged together by CGCA 300. It is appreciated that GCA 100 and CGCA 300 can gang together any suitable number of connectors 106, 306, which can be more than 27 or fewer than 27.

Generally, in order for GCA 100 to be properly connected to CGCA 300, each of the individual connectors 106 is to be properly connected to a corresponding connector 306 of CGCA 300. By design, a proper connection between a connector 106 and a corresponding connector 306 can rely on the application of sufficient mating force.

While this mating force relied on to connect a given connector 106 properly to corresponding connector 306 differs based on the types, as a representative example, specifications for an MMC-type connector 106 suggest a suitable connection force is between 10-20 newtons (N) which converts to about 2.25 to about 4.5 pound force (lbf) in order to properly couple a single connector 106-306 pair. Because GCA 100 and CGCA 300 gang together multiple connectors 106, 306, the individual connection forces can sum for the ganged connectors 100, 300. Thus, in order to properly connect a GCA 100 to a CGCA 300, each comprising 27 connectors 106, 306, the mating force can be on the order of about (27*4.5=)122 lbf, which can be exceedingly difficult to apply during installation, maintenance, or other operations that rely on pairing or mating of ganged connectors such as GCA 100 and/or CGCA 300.

In order to overcome these and other difficulties, the disclosed subject matter relates, in some embodiments, to a push screw apparatus or assembly that can couple and secure a connection between GCA 100 and CGCA 300. The disclosed push screw assembly or apparatus can, in some embodiments, leverage mechanical advantage or force amplification to supply the target mating force based on supplied forces having a lower magnitude than the target mating force. The disclosed push screw assembly or apparatus can, in some embodiments, provide a more comfortable or convenient mechanism by which the supplied forces can be applied. Advantageously, the disclosed push screw assembly or apparatus can facilitate connections for GCA 100 and/or CGCA 300 that can be faster, more efficient, and more reliable, and can do so in a manner that can avoid potential injury to installation personnel or damage to equipment.

To these and related ends, GCA 100 can comprise push screw receiver 202 and receiver pivot 204 introduced above. CGCA 300 can further comprise push screw 308, crank 310, and alignment tab 312, all of which are further detailed in connection with FIG. 5 and subsequent drawings herein. It is appreciated that elements detailed in connection with GCA 100 may instead be implemented on GCGA 300 and vice versa.

### Example Push Screw Assembly for Force Amplification

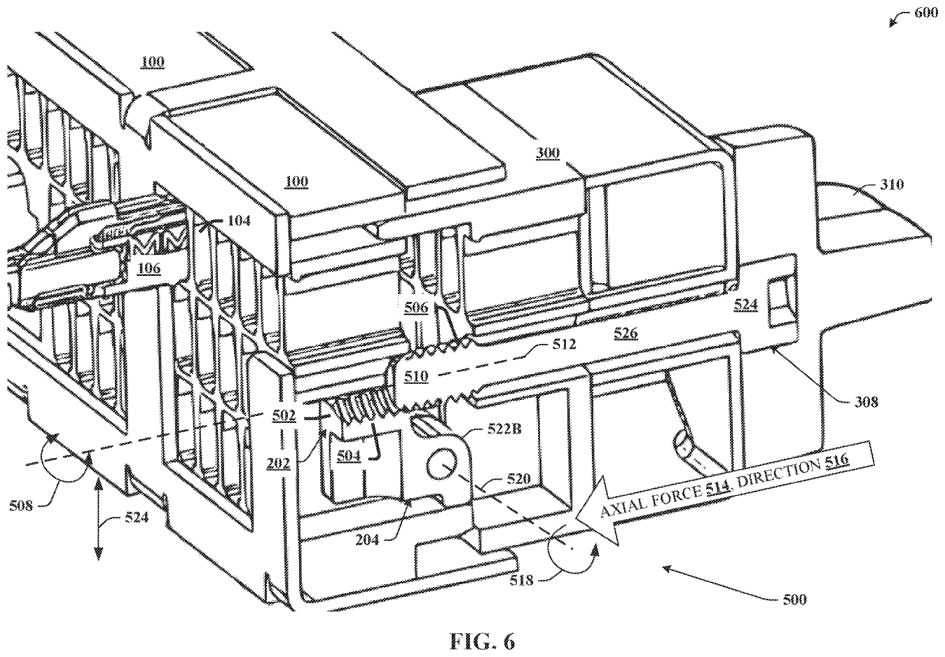

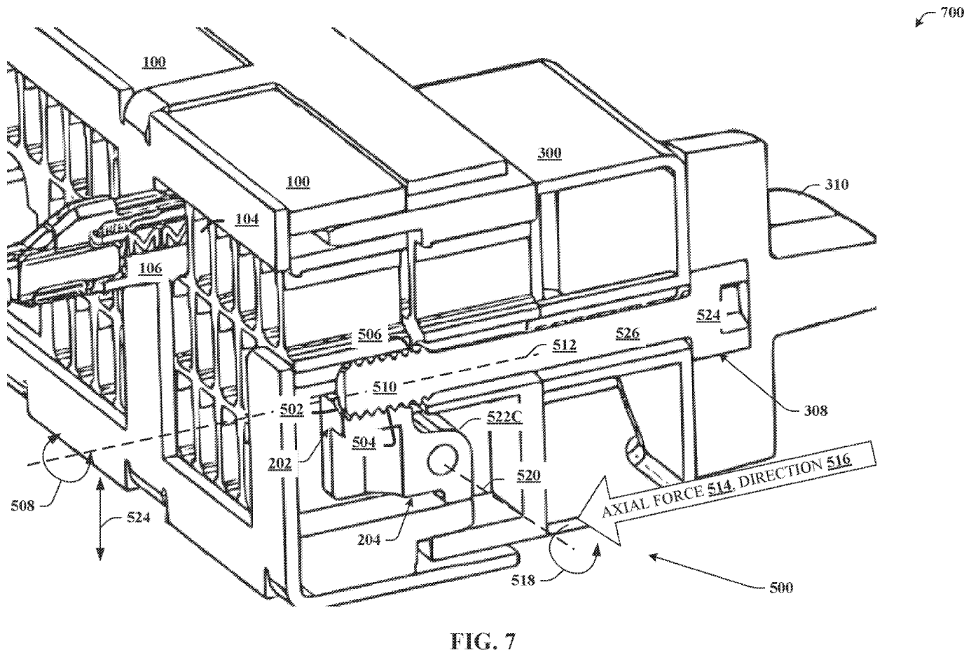

While still referring to FIGS. 1-4, but turning now as well to FIGS. 5-7, an example push screw assembly 500 is depicted in three distinct states that represent various stages of coupling GCA 100 to CGCA 300. FIG. 5 illustrates an example isometric view of an example push screw assembly 500, in an example first state, that facilitates attaching and securing the GCA 100 to the CGCA 300 in accordance with example embodiments of this disclosure. FIG. 6 illustrates an example isometric view 600 of the example push screw assembly 500, in an example second state, that facilitates attaching and securing the GCA 100 to the CGCA 300 in accordance with example embodiments of this disclosure. FIG. 7 illustrates an example isometric view 700 of the example push screw assembly 500, in an example third state, that facilitates attaching and securing the GCA 100 to the CGCA 300 in accordance with example embodiments of this disclosure.

In the disclosed examples, a first portion of push screw assembly 500 (e.g., push screw receiver 202, receiver pivot 204, . . . ) can be associated with GCA 100, whereas a second portion (e.g., push screw 308, crank 310, alignment tab 312, . . . ) of push screw assembly 500 can be associated with CGCA 300, but other arrangements of the detailed elements are envisioned.

In this illustration, GCA 100 and CGCA 300 are in contact. However, it is noted that, prior to such contact, it can be advantageous to properly align GCA 100 and CGCA 300 (e.g., along screw axis 512), as such can simplify connection or potentially avoid improper contact or even damage to various elements. To aid such, alignment tab 312 can be provided. Alignment tab 312 can be situated on interface side 320 of housing 302 (best shown with reference to FIG. 3) and can be configured to enter an alignment slot 206 (best shown with reference to FIG. 2) of CGA 100.

Alignment tab 312 can be configured to extend in an axial direction 516 (e.g., substantially parallel to screw axis 512) farther than does push screw 308.

In other words, alignment tab 312 can interface with alignment slot 206 prior to push screw 308 interfacing with push screw receiver 202. Hence, proper interface between alignment tab 312 and alignment slot 206 can prevent or mitigate improper alignment between push screw 308 and push screw receiver 202. In some embodiments, alignment tab 312 can comprise one or more tapered sections 314 that can aid in the alignment. For example, tapered section 314A represents a first tapered section along one plane of interface, and tapered section 314B represents a second tapered section along a different plane of interface.

With regard to the first portion of push screw assembly 500 (e.g., of GCA 100), as illustrated here and in FIG. 2, such can comprise push screw receiver 202. In some embodiments, push screw receiver 202 can comprise a chamber 502 that can be cylindrical or barrel-shaped, which can be configured to receive threaded section 510 of push screw 308 (of CGCA 300) in a direction substantially along screw axis 512. Chamber 502 can comprise receiver threads 504 that are configured to mate with screw threads 506 (e.g., disposed on threaded section 510) push screw 308.

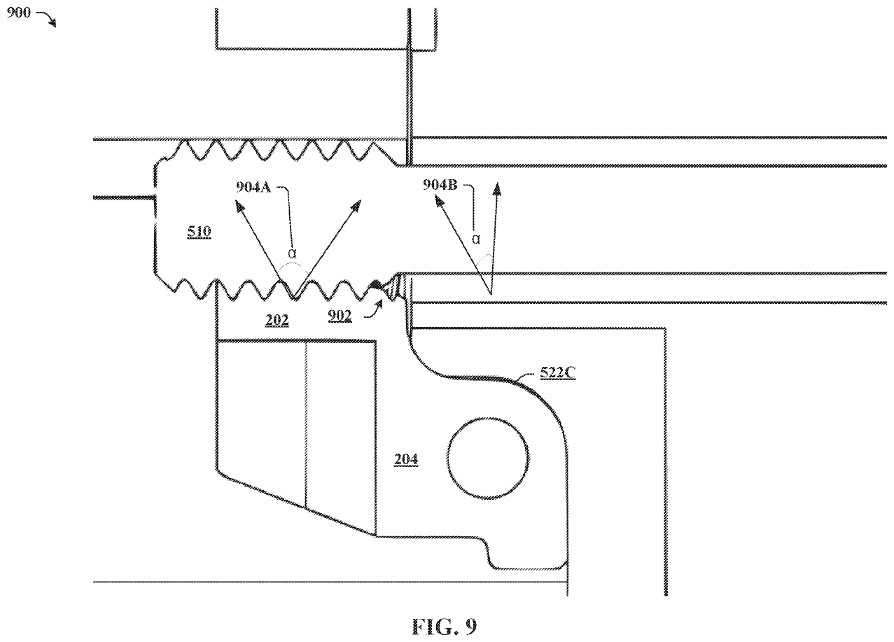

It is understood that, due to existence of receiver threads 504 and matching screw thread 506, push screw 308 would ordinarily be prevented from entering push screw receiver 202 and/or chamber 502 via axial force 514 without stripping or damaging the threads 504, 506. However, the disclosed push screw assembly 500 is designed to permit entrance of push screw 308 into push screw receiver 202 and/or chamber 502 via axial force 514 such that some portion of screw threads 506 bypass or clear some portion of receiver threads 504 without damage. Such is referred to herein as being axially seated and/or closed state 522C, and which is further detailed in connection with FIGS. 7 and 9.

Transitioning from an uncoupled state between GCA 100 and CGCA 300 to the axially seated state that occurs in response to axial force 514 can be accomplished in accordance with the disclosed subject matter via multiple design techniques. For example, shown in FIG. 2, receiver threads 504 do not extend entirely around (e.g., 360 degrees) chamber 502, but rather are only disposed in an arc 508 around screw axis 512 that is less than 360 degrees. For instance, while the ‘bottom’ portion of chamber 502 comprises threads the ‘top’ portion does not. In some embodiments, arc 508 can be in a range between about 75 degrees and about 120 degrees.

As can be understood, because receiver threads only occupy a limited arc 508 around screw axis 512, by temporarily moving push screw receiver 202 (e.g., so receiver threads 504 do not block screw threads 506), push screw 308 can be inserted in direction 516 in response to axial force 514.

In that regard, receiver pivot 204 can enable or facilitate such temporary movement. For example, in response to axial force 514 that is applied in direction 516 (e.g., substantially parallel to screw axis 512), receiver pivot 204 can facilitate rotation 518 of chamber 502 and/or the threaded portion of chamber 502 about pivot axis 520. As illustrated, pivot axis 520 can be substantially perpendicular to screw axis 512.

Hence, receiver pivot 204 can be configured to transition, via rotation 518, from a closed state 522A to an open state 522B, which is shown in connection with FIG. 6. As shown in FIG. 5, the closed state 522A can be a state in which the screw threads 506 do not clear the receiver threads 504. As shown in FIG. 6, the open state 522B can be a state in which push screw receiver 202 is rotated sufficiently to allow screw threads 506 to clear receiver threads 504.

In some embodiments, receiver pivot 204 can comprise a spring device or other compression or tension device configured to provide a force (referred to herein as a rotation force) that is in opposition to axial force 514. Hence, the rotation force can operate to maintain closed state 522A in the face of no axial force 514 or when axial force 514 is less than (e.g., lower magnitude) than the rotation force provided by the spring device.

However, when axial force 514 exceeds the rotation force (e.g., in response to screw threads 506 pushing on receiver threads 504 due to axial force 514), receiver pivot 204 causes at least a portion of push screw receiver 202 to rotate about pivot axis 520, resulting in state 522B in which a first portion of screw threads 506 clear or transition past a second portion of receiver threads 504. Potentially, due to rotation force, each instance of one or more screw threads 506 transitions past a respective one or more receiver thread 504 can be accompanied by an audible click.

Other embodiments are envisioned. For example, in addition to, or potentially an alternative to, receiver pivot 204 operating to rotate 518 push screw receiver 202 about pivot axis 520, receiver pivot 204 may be configured to provide linear motion such as in a direction 524 that is substantially perpendicular to screw axis 512. For instance, chamber 502 can be sectioned and the portion with receiver threads 504 can move or slide (downward in this example) in response to axial force 514. Such could also be in opposition to a spring or other retention force that operates to maintain state 522A.

Regardless, due to application of axial force 514, screw threads 506 are permitted to clear receiver threads 504. Once a sufficient number of receiver threads 504 have been cleared, receiver pivot 204 can cause push screw receiver 202 to return to the closed state as shown in FIG. 7. In state 522C, receiver pivot 204 is in the same position as state 522A; however, in this case, push screw 308 is considered to be axially seated.

As was previously mentioned, in order for GCA 100 to be properly coupled to CGCA 300, each included connector 106 is to be properly coupled to an associated corresponding connector 306. In the example provided above, when summing the individual mating forces of connectors 106, 306, the total mating force for the ganged connectors 100, 300 can be substantial (e.g., over 120 lbf may be needed for 27 MMC-type fiber optic connectors).

In contrast, in order to achieve the axially seated state (e.g., illustrated in FIGS. 7 and 9), axial force 514 can be significantly less than the total mating force. Rather, axial force 514 merely needs to be sufficient to overcome the rotation force of the spring or other mechanism associated with receiver pivot 204 and perhaps a few other forces in order to achieve the axially seated state. So, it can be possible to achieve the axial seated configuration in response to axial force 514 that is an order of magnitude less than the total mating force targeted for proper connection.

However, the axially seated state may not be initially sufficient to properly connect all of the individual connectors 106, 306 to one another. Hence, the disclosed techniques can rely on force amplification and/or mechanical advantage techniques associated with the second portion of push screw assembly 500.

Hence, referring specifically to CGCA 300, CGCA 300 can comprise push screw 308 and crank device 310, both of which were previously introduced. As illustrated in FIGS. 5-7, push screw 308 can comprise head section 524 that can be exposed on a head side (e.g., back side 330) of housing 302. Push screw 308 can further comprise a shank section 526 that extends through housing 302 in axial direction 516.

Furthermore, push screw 308 can comprise thread section 510 that also extends in the axial direction 516 and is exposed on the interface side 320 of the housing 302, as best illustrated via FIG. 3. Thread section 510 can comprise screw threads 506 that are configured to mate with receiver threads 504 of a chamber 502 and/or push screw receiver 202 (e.g., situated on GCA 100). As detailed previously, a first portion of the screw threads 506 are configured to clear a second portion of the receiver threads 504 in response to axial force 514 applied substantially in the axial direction 516, ultimately resulting in the thread section 510 being axially seated in the threaded receiver 202.

Once in the axially seated state, crank device 310 can be utilized to rotate and/or drive push screw 308. It is to be appreciated that crank device 310 can provide force amplification. In other words, the amount of force input to crank device 310 can be less than the total mating force target. Yet, due to the force amplification (e.g., in this case due to the screw leverage action) the total mating force can be achieved more easily.

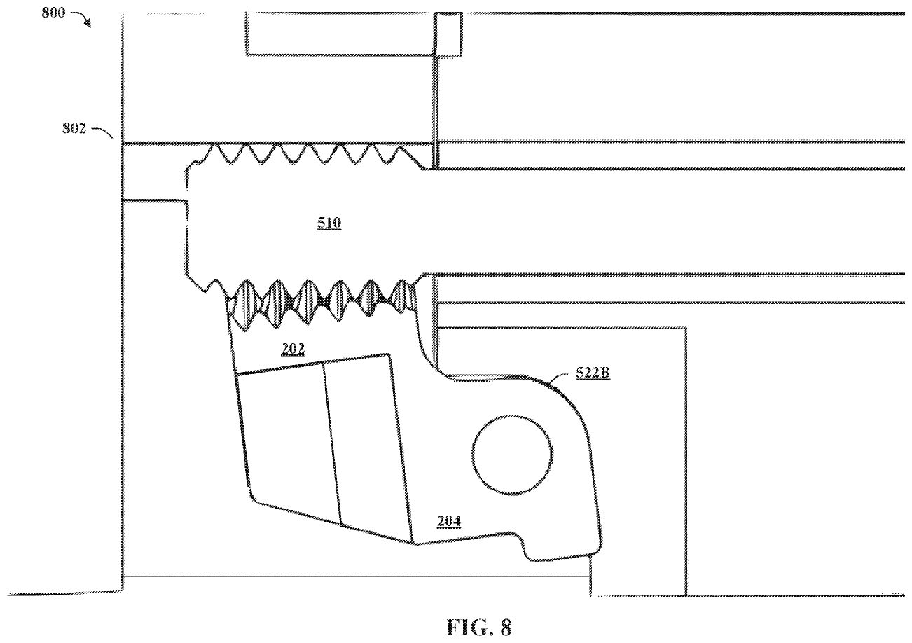

FIGS. 8 and 9 provide additional views of the interaction between the push screw 308 and the push screw receiver 202 when the receiver pivot 204 is in various states, namely in the open state 522B and the closed state 522B, respectively. FIG. 8 illustrates a first example orthogonal cross section view 800 of the example push screw assembly 500 in the example second state 522B in accordance with example embodiments of this disclosure. FIG. 9 illustrates a second example orthogonal cross section view 900 of the example push screw assembly 500 in the example third state 522C in accordance with example embodiments of this disclosure.

With reference to FIG. 8, as can be seen, in response to axial force 514, screw threads 506 exert a force on corresponding receiver threads 504, causing push screw receiver 202 to rotate via operation of receiver pivot 204 detailed previous.

Hence, in this open state 522B screw threads 506 clear receiver threads 504. Because receiver threads 504 do not span entirely around chamber 502 of push screw receiver 202, retainer 802 does not interfere with insertion of push screw 308. Retainer 802 can represent a smooth (e.g., non-threaded) surface such as the interior surface of chamber 502.

With reference to FIG. 9, as can be seen, once push screw 308 has transitioned a sufficient amount into push screw receiver 202 and/or a sufficient number of screw threads 506 have cleared a sufficient number of receiver threads 504 in response to axial force 514, receiver pivot 204 can return to the closed state 522C, which in this case can be the axially seated state. As detailed above, thereafter, crank device 310 can be operated to further drive push screw 308 into push screw receiver 202 in order to provide the target total mating force to properly couple GCA 100 to CGCA 300.

In some embodiments, receiver threads 304 can comprise a tapered portion 902. Tapered portion 902 can represent a given receiver thread 304 having shorter height (e.g., distance from chamber 502) than other receiver threads 304. Typically, tapered portion 902 can be implemented to one or more receiver threads 304 that are at or near the entrance of push screw receiver 202, as shown. This shorter height can result in improved clearance for screw threads 506 when receiver pivot 204 is in open state 522B. In some embodiments, the sloping nature of tapered portion 902 can result from one or more receiver threads 504 being shorter or filed down relative to other receiver threads 304. In some embodiments, tapered portion 902 can result from chamber 502 having a conical or tapered structure near the entrance of push screw receiver 202.

As illustrated in this cross-section view, screw threads 506 and receiver threads 504 exhibit complementary saw-tooth patterns of a given angle 904A. Threading can be finer or coarser than shown. In tests, it is observed that finer threading can accomplish greater mating forces. However, coarser threading results in a lower total area of contact between screw threads 506 and receiver threads 504, reducing a total amount of frictional forces. Thus, coarser threads may provide greater force amplification or otherwise result in crank device 310 being easier to turn in order to achieve the total mating force.

Other angles 904B are also contemplated. For example, in some embodiments, the interfaces side of contact of threads 504, 506 can be similar to that shown in connection with angle 904A, whereas the opposite side can be substantially at a 90 degree angle with respect to screw axis 512. Such can maintain the same operation with respect to inserting push screw 308 via axial force 514, but may provide a more stable arrangement when turning crank device 310 and/or allow the rotation force of the spring device associated with receiver pivot 204 to be reduced.

### Second Example Ganged Connector Mating Pair

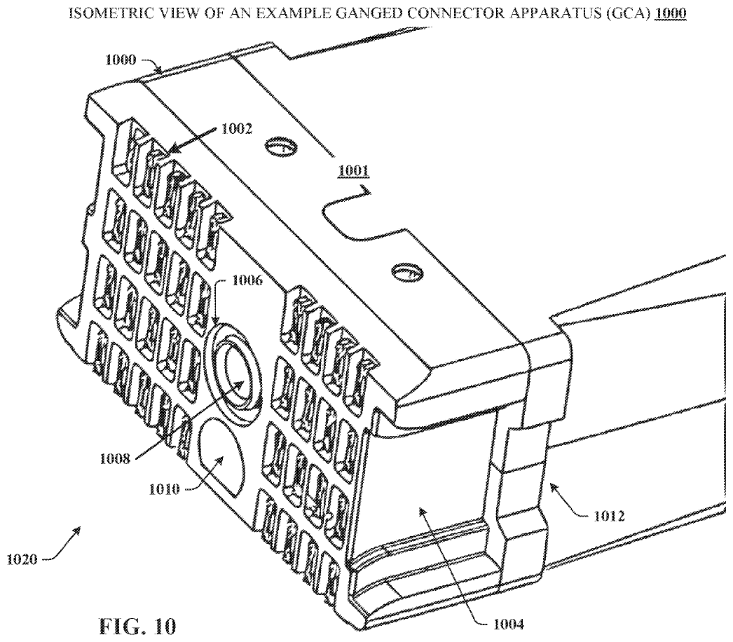

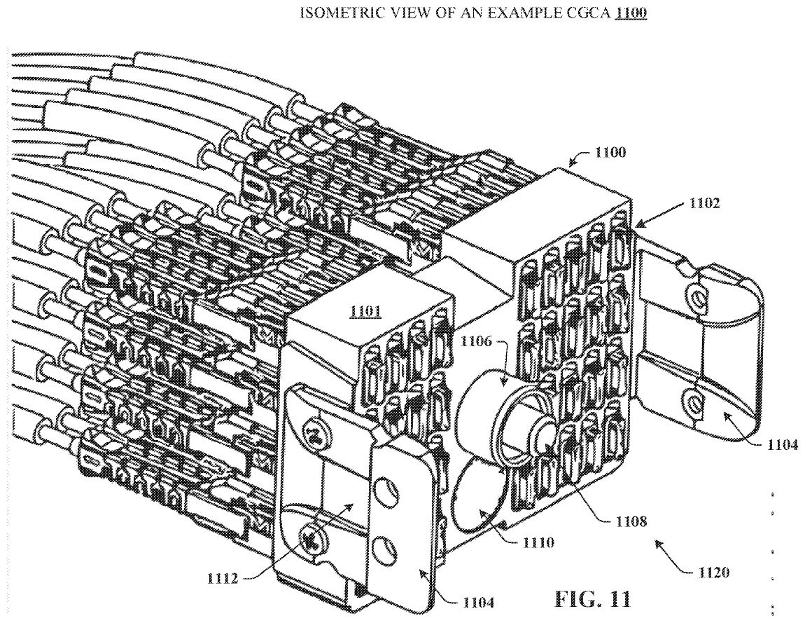

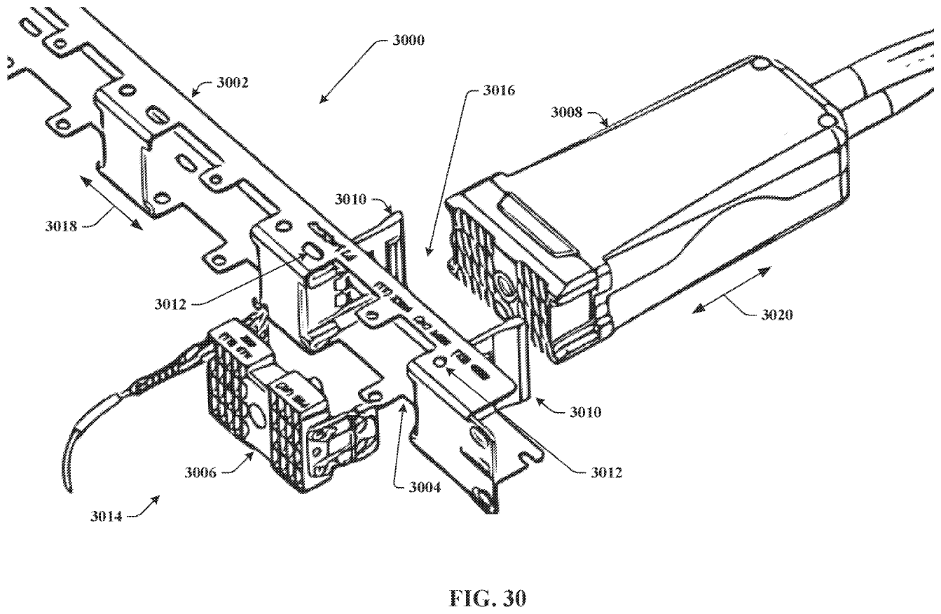

While FIGS. 1-9 illustrate a first example GCA-CGCA mating pair (e.g., GCA 100 and CGCA 300), FIGS. 10 and 11 illustrate a second example GCA-CGCA pair (e.g., GCA 1000 and CGCA 1100), which is used as representative for the remainder of this disclosure. It is understood that a given GCA 100, 1000 or CGCA 300, 1100 can couple to a patch panel (e.g., patch panel 3002 of FIG. 30) from the front side, such as the case with the illustrated orientation of GCA 100 in FIGS. 1 and 2; or couple to the patch panel from the rear, as with the illustrated orientation of GCA 1000 in FIG. 10.

High-density multi-fiber connector assemblies are becoming increasingly relied upon in data center and telecommunication environments. While high-density multi-fiber connectors, such as SFF and VSFF connectors, can significantly reduce space requirements and simplify cable routing, these connectors also pose a set of difficulties for installers, operators, and technicians. The present disclosure addresses several of these challenges, many of which can become severe obstacles when working with ganged connectors in large cabinets or cramped spaces.

One challenge relates to compression force requirements. For example, when multiple individual connectors (e.g., VSFF type MMC connectors, other multi-fiber ferrules, or other connector types) are ganged together, the total force required to achieve proper mating can be substantial. In some configurations with dozens of ferrules, the mating force can exceed 100 pound-force (lbf). Conventional designs often demand that an installer exert this large force in a single step, which can be impractical for a single person, difficult to maintain in blind or overhead installations, and prone to misalignment damage.

Another challenge relates to blind or deep-cabinet installations. Modern data cabinets can be extremely deep, making it impossible to reach from the rear to the front to plug in connectors directly. Traditional connector solutions typically assume full access for both sides of a patch panel (where connectors are brought together) or a shallower cabinet depth. In these deeper enclosures, aligning and feeding ganged connectors from the rear to the front, particularly when multiple connectors must be simultaneously engaged, is cumbersome and often requires more than one person. If the installer cannot see or adequately guide the connector during installation, misalignment and potential connector or cable damage become more likely.

Still another challenge relates to ferrule alignment difficulties. Ganged connector assemblies may include dozens of individual fibers in tight, high-density ferrule arrays. Achieving a robust and accurate connection demands precise alignment of each ferrule pair. Even small angular or translational misalignments can degrade signal performance or cause connector damage. Existing solutions often lack sufficient “pre-alignment” mechanisms, relying instead on the connector ferrules themselves to guide insertion. This can result in damaged, bent, or broken ferrules, especially if high mating force is applied prematurely.

Yet another challenge relates to labor-intensive, two-person installations. In many cases, large-scale ganged connector systems require one technician to hold or route the cable from the rear while another installs or tightens from the front. This creates scheduling inefficiencies and added labor cost. Current solutions that try to solve one-person installation either compromise alignment or become unwieldy for the user, yielding a high risk of partial engagement or repeated attempts.

Connector contamination and dust management can also be a significant issue for installation. Contamination of connector end faces is a major concern in fiber-optic networks. Dust particles can lead to performance degradation or even damage. Existing dust cap systems often require removing each cap individually at the final moment of connection, increasing the time connectors remain exposed to airborne contaminants. Moreover, if multiple rows or columns of connectors must be uncapped one by one, the process is tedious and contamination risk rises for those connectors uncapped early in the process.

Limited installation tools for securing and guiding can also be problematic. While some designs incorporate simple latching or generic tray systems, these other solutions rarely address the full complexity of feeding a large multi-fiber trunk cable through deep cabinets to ensure a secure, guided path. Without proper keying or slotting, connectors can rotate or pivot out of alignment, or might even be fed in according to an improper orientation. Likewise, existing trays or guide rails may not provide sufficient tactile or visual feedback to confirm correct orientation of a bulky ganged assembly.

Furthermore, inefficient post-installation maintenance can be problematic. Even after the initial installation, service activities such as re-routing or upgrading cables can be complicated when dust caps, alignment, and trunk feeding solutions are not optimized. Personnel must repeat the difficult installation maneuvers that introduced risk the first time, often with limited space in fully populated racks.

The disclosed ganged connector system, potentially including a magnet detent mechanism, tailored alignment elements, a spring-biased nut or magnet, a tray or drawer slide for blind-feed applications, and a multi-stage dust cap solution, can address the aforementioned challenges by simplifying single-person installations, reducing alignment errors, mitigating contamination, and easing the application of high mating forces. The various features can be combined or used selectively according to the needs of a particular installation environment, thereby offering a unified approach to tackling many of the persistent challenges in dense fiber optic connectivity.

### Example Ganged Connector Alignment Elements

By way of introduction to the second example ganged connector module, consider FIGS. 10 and 11, which respectively depict an example GCA 1000 and an example CGCA 1100. GCA 1000 can be configured to mate with CGCA 1100 and therefore, by convention, one may be referred to as a male type ganged connector with the other being referred to as a female type ganged connector. However, it is appreciated that the disclosed elements or techniques can be implemented according to a different convention. For example, elements or aspect detailed herein in connection with GCA 1000 may instead be associated with CGCA 1100 and vice versa. Likewise, any element associated with GCA 1000 may in addition or in the alternative be associated with

FIG. 10 shows an example isometric view of a second example GCA 1000 that can be configured to mate with a second example CGCA 1100 in accordance with various embodiments of this disclosure. This example isometric view is from a front side 1020 perspective (also referred to herein as a front face).

FIG. 11 shows an example isometric view of the example CGCA 1100 in accordance with various embodiments of this disclosure. This example isometric view is from the perspective of a front side 1120 of the CGCA 1100 (also referred to herein as a front face), when oriented for connection with the GCA 1000.

As illustrated, GCA 1000 can comprise housing 1001. Housing 1001 can comprise a group or array of openings that are configured to receive connectors 1002. Thus, when deployed, all or a portion of openings can be fitted with connectors 1002, as shown. As a representative, though non-limiting example, connectors 1002 can be fiber optic ferrules that are configured or compliant with any suitable connector type or form factor, including, for example, a miniature multi-channel (MMC) connector, a multi-fiber push on (MPO) connector, a multi-fiber termination push-on (MTP) connector, or another suitable type of connection interface. In the present example, and as used as a non-limiting example herein, connector 102 is an MMC connector. Other connector types are contemplated including copper-type connectors, such as an RJ-45 connector, or another suitable type of connector, including fiber optic type connectors, copper type connectors, and beyond.

In some embodiments, housing 1001 of GCA 1000 and/or housing 1101 of CGCA 1100 can further comprise one or more of various alignment elements that can be configured to facilitate an aligned state in which GCA 1000 aligns with CGCA 1100 prior to application of a compression force sufficient to connect the group of MMC connectors 1002 to the corresponding group of MMC connectors 1102.

For example, GCA 1000 can comprise at least one recess 1004 that can be configured to mate with at least one wing 1104 (also referred to herein as ears) of CGCA 1100. As with other alignment elements described herein, in some embodiments, recess 1004 can instead be present on CGCA 1100, while corresponding wings 1104 are situated on GCA 1000. As illustrated, recess 1004 and wing 1104 can be situated on the side(s) of the associated ganged connector housing 1001, 1101 and can be configured to mate with one another. In other words, recess 1004 and wing 1104 can be situated on the side(s) of the associated ganged connector housings 1001, 1101 and may be configured to mate with one another in a way that reduces rotational or lateral misalignment. Some or all alignment elements can be keyed or polarized so they mate only in a single orientation. For instance, recess 1004 may have a different shape at the top than at the bottom, and wing 1104 can have a complementary shape that prevents accidental upside-down engagement.

In some embodiments, GCA 1000 or CGCA 1100 may also comprise a tenon element 1106 or mortise element 1006. Tenon element 1106 can be situated on and protrude from a front face of the associated ganged connector and may be configured to slide into mortise element 1006 prior to achieving the aligned state. Tenon element 1106 need not be a fully solid structure. Rather, tenon element 1106 may be substantially hollow and operate as a housing or retainer for a threaded bolt 1108. Mortise 1006 can likewise serve as a housing or retainer for an associated threaded nut 1008 that can be used to apply a compression force. In some embodiments, the tenon-and-mortise arrangement can be off-center or asymmetrical so that they only fit together in one orientation, thereby helping to prevent misalignment.

GCA 1000 can further comprise magnet 1010 that may form part of a magnetic detent device. Magnet 1010 can be configured to magnetically couple to a magnetically responsive material 1110 located on CGCA 1100 (or vice versa), thereby promoting early-stage retention prior to final compression. It is appreciated that magnetically responsive material 1110 can itself be a magnet (e.g., oriented for opposite polarity). This magnetic detent can draw GCA 1000 closer to CGCA 1100 when the two ganged connectors are brought into proximity and can help prevent inadvertent separation if either of the housings 1001, 1101 are momentarily bumped or partially engaged.

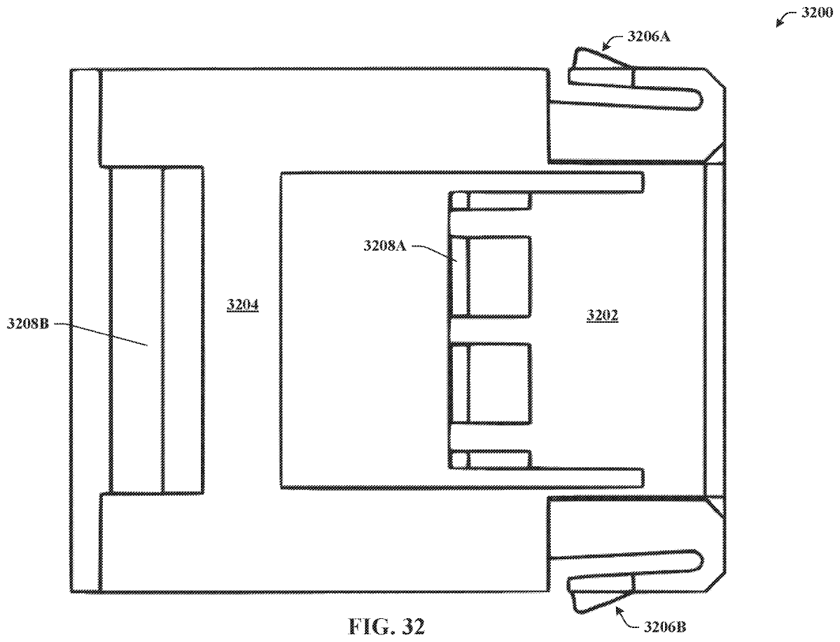

As illustrated, housing 1001 can comprise recess 1012. Likewise, wing 1104 can comprise recess 1112. These two recesses 1012, and 1112 can be configured to mate with protrusions (e.g., protrusions 3208A and 3208B) further detailed in connection with FIGS. 32-35B. Such can in some embodiments represent elements of a snap-fit joint, that together comprise a male (e.g., protrusions) and a female (e.g., recesses) component. It is appreciated that although the GCA 1000 and CGCA 1100 are shown in this example comprising the female element (e.g., recesses 1012 and 1112), with the mating element comprising the male elements (e.g., protrusions 1408A and 1408B), in other embodiments that paradigm could be reversed. Further, while the remainder of the examples are demonstrated with respect to GCA 1000 and CGCA 1100, it is to be understood that GCA 100 and CGCA 300 can also comprise substantially similar mating elements such as one or more recess 1012, 1112 or one or more protrusions 3208A, 3208B.

### Alignment Elements Facilitating Example Alignment

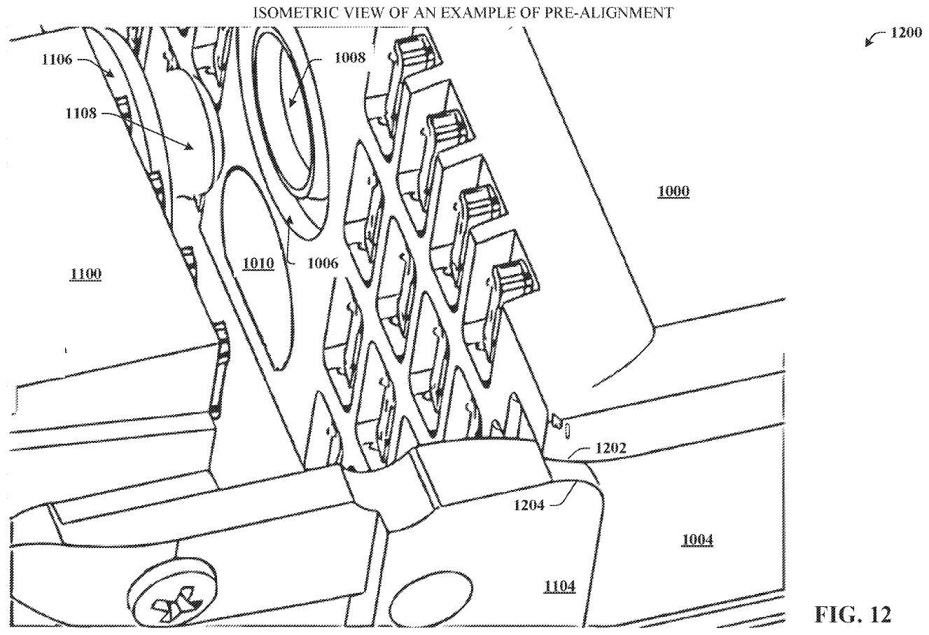

FIG. 12 shows an example isometric view 1200 of an example of pre-alignment depicting a scenario in which the GCA 1000 is moved into proximity with the CGCA 1100 in accordance with various embodiments of this disclosure. This view can be considered a “pre-alignment” state, where one or more alignment elements begin guiding the housings 1001, 1101. In the illustrated example, recess 1004 may comprise a tapered portion 1202, while wing 1104 may comprise a corresponding tapered portion 1204. These cooperative tapers can help the two housings orient in a smoother fashion, minimizing risks of angled collisions or partial engagements. Either or both elements 1004, 1104 can be keyed as mentioned previously. For example, the tapered portions 1202, 1204 at the top may differ from those at the bottom, ensuring that wing 1104 cannot be flipped or rotated out of alignment relative to recess 1004.

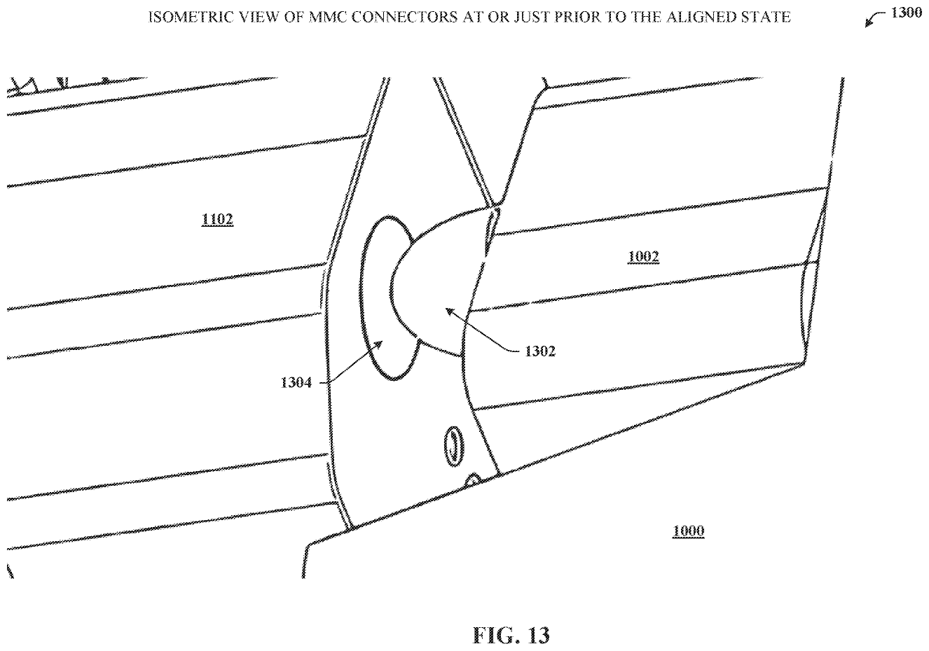

FIG. 13 shows an example isometric view 1300 of example MMC connectors at or just prior to the aligned state in accordance with various embodiments of this disclosure. Hence, FIG. 13 illustrates an isometric view (somewhat magnified) in which MMC connectors 1002 of GCA 1000 and MMC connectors 1102 of CGCA 1100 approach a more fully aligned state. Each MMC connector 1002 may include a bull nose 1302, and each MMC connector 1102 may include a complementary MMC receptacle 1304. In this illustrated situation, bull nose 1302 can be aligned with receptacle 1304 to allow ready mating. By presenting a tapered or rounded leading face, the connector 1002 can reduce the likelihood of damage or contamination during final positioning. This arrangement may be considered to be at or very close to the aligned state, as the group of connectors 1002 is substantially aligned and adjacent to the group of connectors 1102.

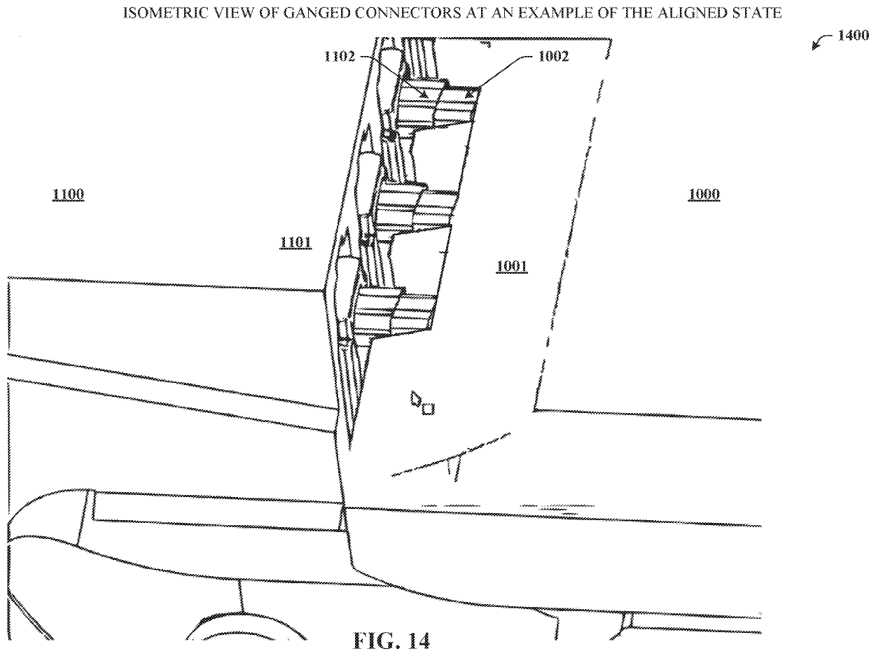

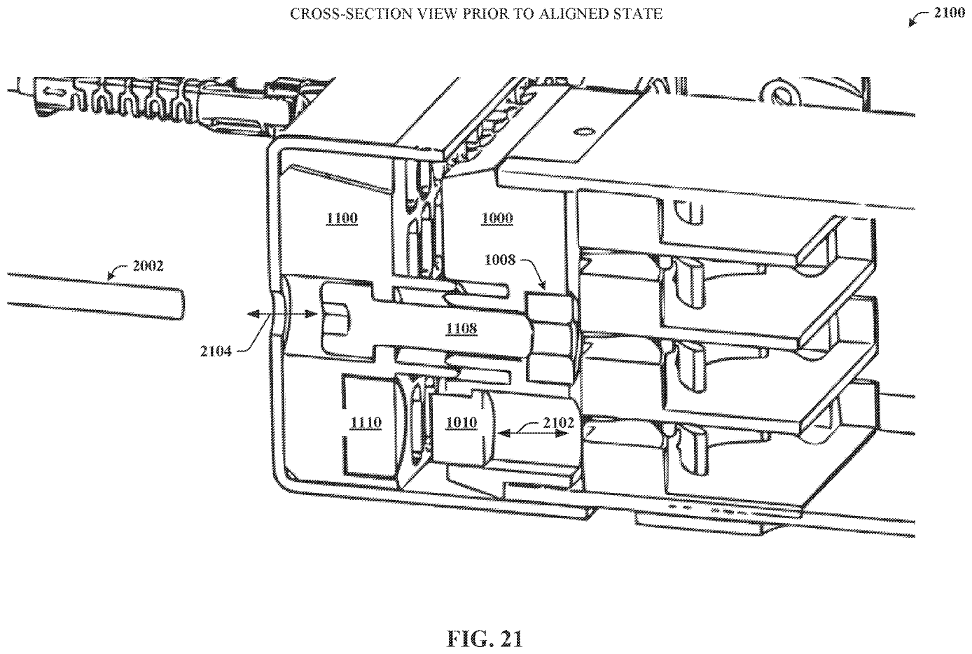

FIG. 14 depicts an example isometric view 1400 of the ganged connectors according to another example of the aligned state in accordance with various embodiments of this disclosure. Thus, view 1400 provides an isometric view that exemplifies a scenario in which the MMC connectors 1002 of GCA 1000 are in direct contact with the MMC connectors 1102 of CGCA 1100, with nose 1302 inserted into receptacle 1304 (not shown, but see FIG. 13). Once such contact is established, the individual MMC connectors 1002, 1102 can be in proper alignment and further forces bringing the ganged connectors can be applied until housing 1001 makes contact with housing 1101, which can operate as a torque limiter. Hence, installation personnel may apply a suitable compression force, for instance, via threaded bolt 1108 and threaded nut 1008 (see, e.g., FIGS. 10-11), with this installation process further detailed in connection with FIGS. 21-23. During this phase, the magnet 1010 and magnetically responsive material 1110 may continue to provide a magnetic detent that can maintain or assist in maintaining alignment before and during final tightening.

### Example Alignment Via Slotted Tray and T-Members

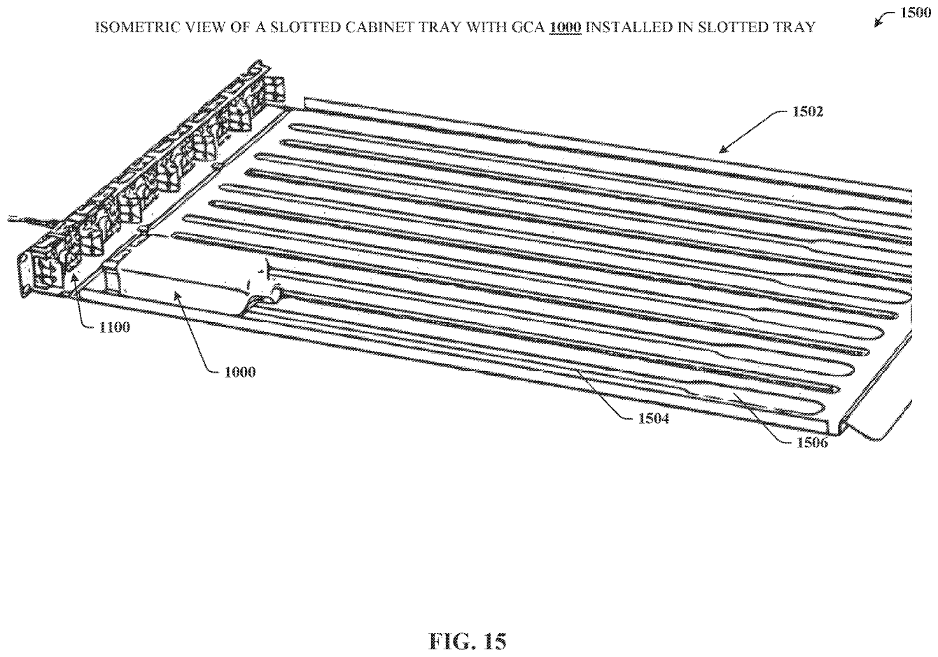

FIG. 15 depicts an example isometric view 1500 of an example cabinet tray with the GCA 1000 installed in the slotted tray 1502 in accordance with various embodiments of this disclosure. In some deployments, data cabinets can extend 126-40 inches or more in depth from front to back. Such lengths can be significantly greater than an ordinary arm-length, making it difficult for a single installer to maneuver connectors into position without assistance.

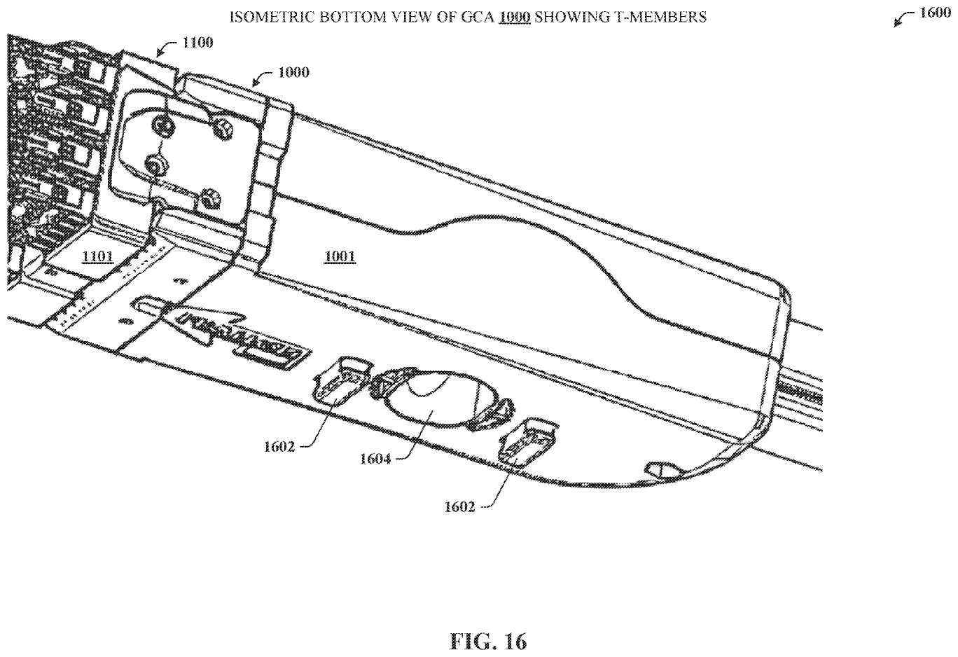

Slotted tray 1502 can address this concern by providing a guided path for GCA 1000 to be fed from a rear region of the cabinet toward a mating assembly at the front. The illustrated slotted tray 1502 can include slot 1504, which may run longitudinally from a rear side, where the slot may be comprised of a wider region (e.g., wide slot section 1506), to a front side aligned with CGCA 1100. This wide slot section 1506 can permit insertion of a T-member 1602 (see FIG. 16) at a convenient angle or orientation, after which GCA 1000 may be slid forward (e.g., using a tool or the cabling) along slot 1504 in a more constrained alignment.

By moving GCA 1000 from the back of the cabinet to the front through slot 1504, installation can be accomplished by a single person working primarily from the back side until magnet 1010 of GCA 1000 engages magnetically responsive material 1110 of CGCA 1100, and then subsequently from the front side of the cabinet, reducing the chance of misalignment of, or damage to, GCA 1000, CGCA 1100, or the sub-components therein. In some scenarios, installation personnel may even hear an audible click or other sound as magnet 1010 engages with magnetically responsive material 1110, which can be relied upon to indicate the aligned state between GCA 1000 and CGCA 1100 has been achieved prior to installation personnel moving from the rear side to the front side of the cabinet for tightening via application of the compression force.

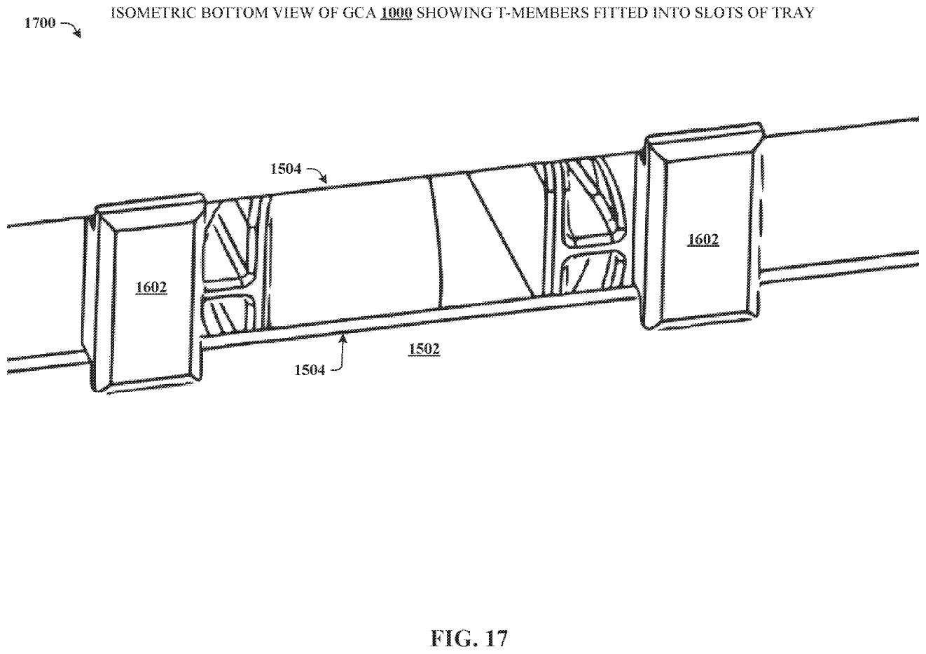

FIG. 16 provides an isometric bottom view 1600 of the ganged connectors GCA 1000 and CGCA 1100, showcasing a set of one or more T-members 1602 secured to the underside of housing 1001 in accordance with various embodiments of this disclosure. In some embodiments, each T-member 1602 can be formed from a rigid material and shaped so that T-member 1602 can interlock with or nest inside the contour of slot 1504 in tray 1502. The drawing in FIG. 16 does not depict tray 1502 (but see FIG. 17), thereby highlighting the underside geometry of T-members 1602.

These T-members 1602 can function as alignment elements by preventing rotational or lateral movement of GCA 1000 once seated in the narrower section of slot 1504. In addition, T-members 1602 can be keyed or polarized to ensure that they only enter the tray slot in a single orientation, for instance, by making the T-member 1602 taller on one side or offset from the center, thereby preventing an upside-down or backward insertion. This approach can help reduce mistakes when an installer must feed the ganged connector blindly into place.

Aperture 1604 can represent a core out for an interior post. It is appreciated that in embodiments that do not rely on slotted tray 1502, or in some situations even while using slotted tray 1502, aperture 1604 can double as a point of purchase for an installer's fingers to aid in positioning GCA 1000 within the cabinet.

FIG. 17 offers an isometric bottom view 1700 of GCA 1000 with T-members 1602 engaged within slotted tray 1502 in accordance with various embodiments of this disclosure. In this view, T-members 1602 can be seen occupying slot 1504, indicating that GCA 1000 has been moved or slid forward from the rear of the cabinet toward its mating CGCA 1100 at the front. The wide slot section 1506 shown in FIG. 15 can be positioned at the rear region of tray 1502, enabling each T-member 1602 to pass through at an early phase of the installation. As shown here, once T-members 1602 clear the wide slot section 1506, T-members 1602 can remain constrained by the narrower geometry of slot 1504 (reference numerals 1504 bound the slot diameter), thereby guiding GCA 1000 in a linear path aligned with CGCA 1100.

Such a guided approach may significantly reduce the force or dexterity needed to complete the connection and can help ensure that any additional alignment features (e.g., magnet 1010, wing 1104, recess 1004) properly engage by the time GCA 1000 reaches CGCA 1100 at the front of the cabinet. These mechanisms can simplify installation procedures in deeper enclosures and also mitigate risks associated with bending or twisting high-density cables as they are moved into place within the cabinet.

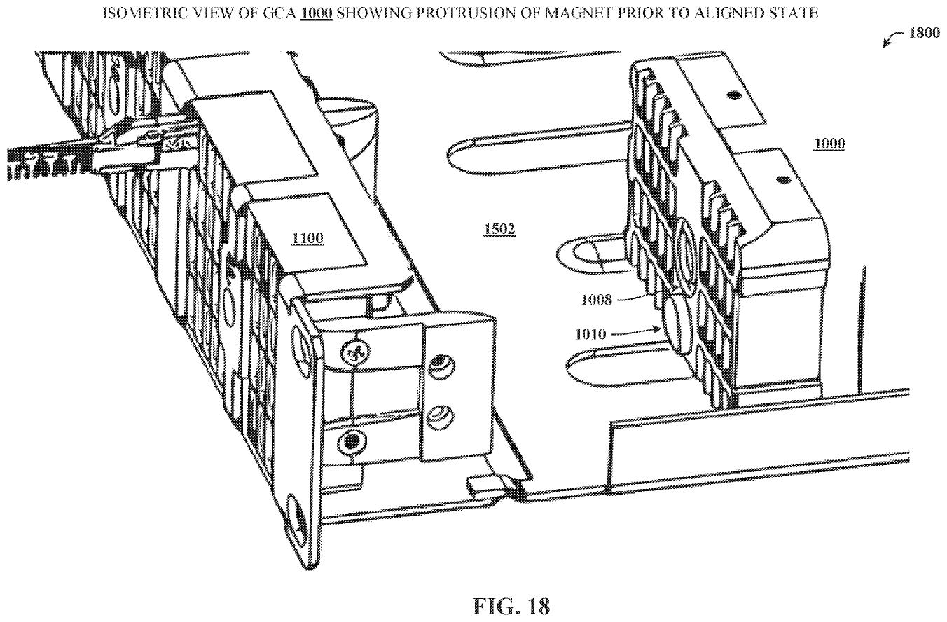

FIG. 18 illustrates an isometric view 1800, depicting a second embodiment in which magnet 1010 can protrude forward relative to the front face plane of GCA 1000, thereby permitting earlier contact with CGCA 1100 in accordance with various embodiments of this disclosure. In this depiction, GCA 1000 is shown on slotted tray 1502, situated some distance away from CGCA 1100 so that the protruding nature of magnet 1010 can be clearly observed.

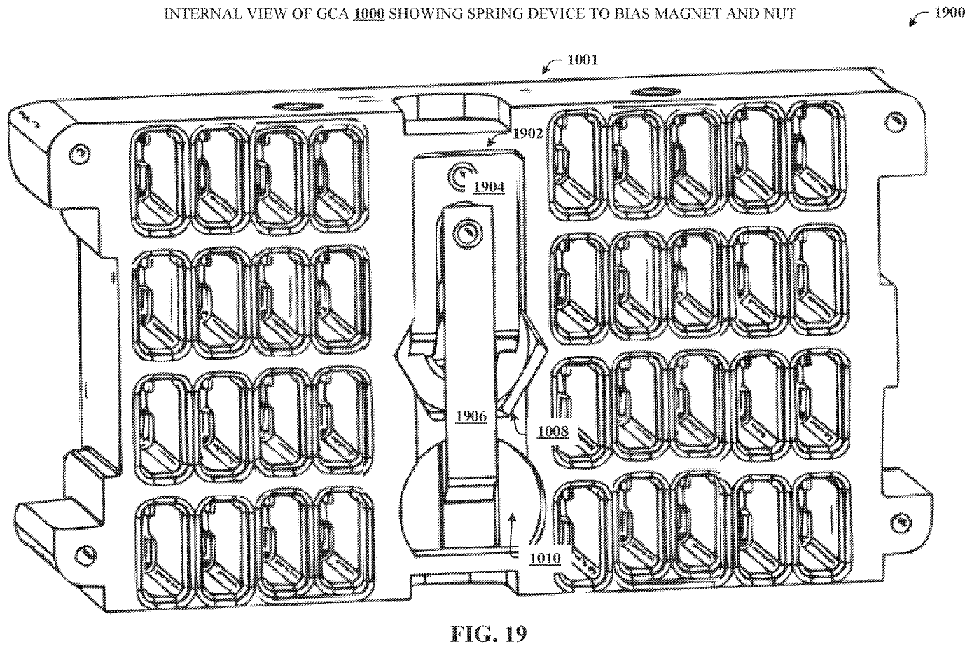

In some embodiments, magnet 1010 can remain flush with the front surface of GCA 1000 (e.g., see FIG. 12) until contact is made, whereas in other embodiments, such as that shown here, magnet 1010 can be free floating. This free-floating configuration can allow magnet 1010 to extend in a forward direction and begin engaging magnetically responsive features (e.g., with magnetically responsive material 1110) of CGCA 1100 sooner in the mating process. Both approaches can achieve pre-alignment and early retention of GCA 1000 to CGCA 1100. In one case, the magnet 1010 may simply remain fixed in a recess of housing 1001, while in another case, the magnet 1010 can be mounted in a chamber that permits it to slide and protrude (e.g., see FIGS. 19 and 21-23). Either configuration can be combined with a slotted tray arrangement, T-members 1602, or other alignment elements to reduce the risk of incomplete engagement or angular collision.

### Example Spring and Free Floating Elements

FIG. 19 provides a lateral cross-section internal view 1900 of GCA 1000 that reveals a spring device 1902 situated within housing 1001 in accordance with various embodiments of this disclosure. In this example, spring device 1902 may be formed as a leaf spring 1902, but it is understood that any suitable spring device or bias-creating device can be employed. The leaf spring 1902 can operate to apply a bias force to one or both threaded nut 1008 and magnet 1010. For example, leaf 1904 can apply a force to threaded nut 1008, while a second, potentially independent leaf 1906 can apply the same or a different amount of force to magnet 1010. In some embodiments, leaf 1904 can contact threaded nut 1008 in a manner, as shown with twin points of contact on threaded nut 1008 that enables clearance of threaded bolt 1108 once threaded bolt 1108 is tightened into threaded nut 1008.

By applying a bias in a forward direction, leaf spring 1906 can coax magnet 1010 outward so that magnet 1010 can protrude, as seen in FIG. 18, e.g., when GCA 1000 has not yet reached an aligned state with CGCA 1100. When GCA 1000 is pressed more firmly into contact, magnet 1010 can retract against the spring force of leaf spring 1902, allowing the connectors 1002, 1102 of GCA 1000 and CGCA 1100, respectively, to be brought together smoothly for proper engagement. Similarly, the bias provided by the spring device 1902 can maintain threaded nut 1008 in a favorable position to receive or engage a corresponding bolt (e.g., threaded bolt 1108), reducing the need for an installer to manually hold the nut in place while alignment is completed.

In practice, this combination of free-floating magnet 1010 and spring-biased nut 1008 can be beneficial in at least two respects. First, the user may slide GCA 1000 forward along slotted tray 1502 until magnet 1010 magnetically couples with the magnetically responsive material 1110 disposed in CGCA 1100, thus establishing a temporary retention to hold GCA 1000 in partial engagement with CGCA 1100. Second, when the final compression force is applied (e.g., via a threaded coupling between threaded nut 1008 and threaded bolt 1108), nut 1008 can be reliably positioned, and magnet 1010 may compress as needed without breaking alignment. These features can help accommodate variations in cabinet depth, cable routing challenges, and the difficulties that arise when only one person is available to manage the alignment and connection of dense multi-fiber assemblies.

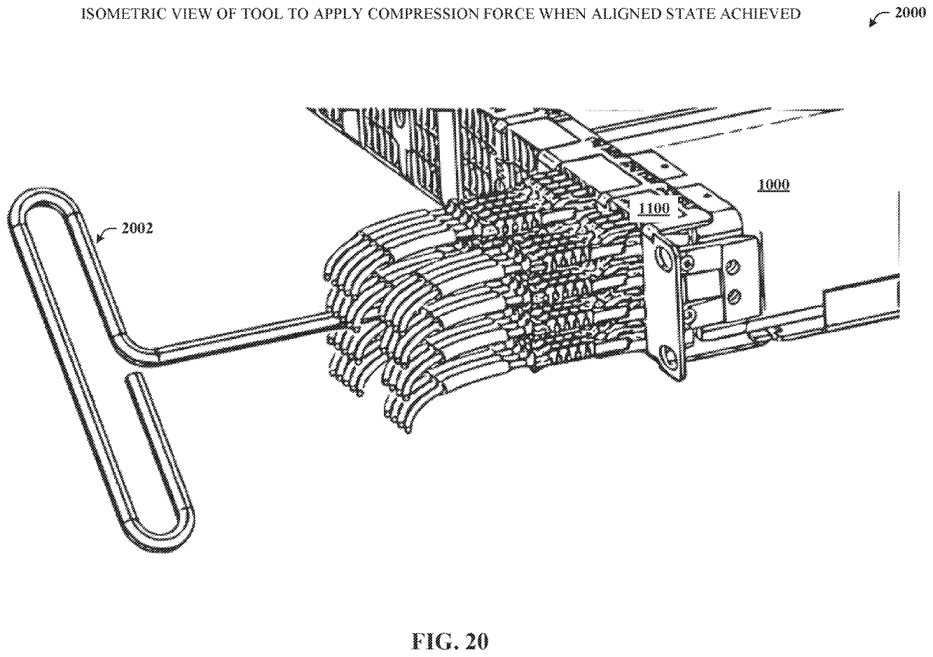

FIG. 20 presents an isometric view 2000 of GCA 1000 and CGCA 1100 in an aligned state, with a tool 2002, in this case a large Allen wrench, shown in accordance with various embodiments of this disclosure. Although tool 2002 is depicted as an Allen wrench in FIG. 20, any suitable tool 2002 can be used. In this illustration, tool 2002 is depicted passing through the cluster of MMC connectors 1102 on CGCA 1100 and to engage threaded bolt 1108 that can reside at least partially in tenon element 1106.

Once GCA 1000 and CGCA 1100 have reached their aligned state, a compression force may still be required to achieve full mating of all connectors 1002 and 1102 of GCA 1000 and CGCA 1100, respectively. Specifications for certain data connectors (e.g., MMC connectors 1002, 1102) indicate a suggested mating force of 10-20 Newtons (N), which translates to roughly 2.25-4.5 pound-force (lbf). These specifications are not intended to be limiting. In practice the mating force could be more or less for a given MMC connector 1002, 1102. In the context of ganged connectors such as GCA 1000 mating with CGCA 1100, a large number of individual MMC connectors 1002, 1102 are ganged together, so that the mating force for an individual mating between connector 1002 and connector 1102 may be multiplied by the number of connectors 1002, 1102 housed by GCA 1000 and/or CGCA 1100. Such might readily exceed hundreds of lbf.

It can be challenging for a single installer to apply or maintain such force by hand, particularly in a blind or overhead scenario. By leveraging a tool, such as tool 2002, to rotate threaded bolt 1108 against a corresponding threaded nut 1008 (see FIGS. 21-23), the required force can be distributed and generated more efficiently. This arrangement may provide mechanical advantage functionality, thereby allowing the user to achieve or exceed the necessary compression force while exerting a fraction of that total force directly.

FIG. 21 illustrates an example longitudinal cross section of the alignment and mating of GCA 1000 and CGCA 1100 depicting an internal view 2100 that shows the ganged connectors prior to the aligned state in accordance with various embodiments of this disclosure. This view illustrates the positions of threaded nut 1008, threaded bolt 1108, magnet 1010 (shown protruding), and magnetic responsive material 1110 prior to the aligned state of GCA 1000 and CGCA 1100. In this depiction, magnet 1010 can be free to slide along an axis suggested by reference line 2102, and bolt 1108 can be free to move along a second axis indicated by reference line 2104. In some embodiments, threaded nut 1008 can also be free floating in a similar manner. Because GCA 1000 and CGCA 1100 are not yet fully aligned, magnet 1010 can protrude significantly to promote earlier magnetic engagement with magnetically responsive material 1110. The arrangement can help pull or hold GCA 1000 in approximate alignment with CGCA 1100, even though the connectors are not yet in final contact.

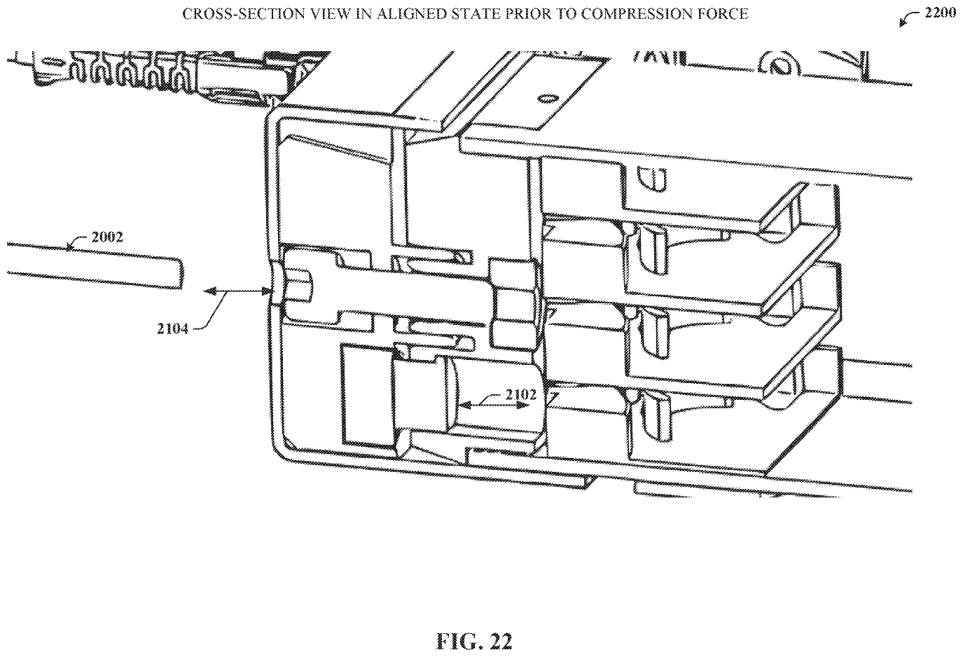

FIG. 22 shows a similar cross-section perspective 2200 at a point where the GCA 1000 and CGCA 1100 have reached an aligned state but before any substantial compression force has been applied in accordance with various embodiments of this disclosure. Magnet 1010 may still protrude, but potentially to a lesser degree than in FIG. 21. The connectors 1002 and 1102 can be in physical contact or close contact, and threaded bolt 1108 can be poised to engage nut 1008. At this stage, only minimal force may be keeping the two assemblies together, such as, for example, by using a combination of magnet-based retention and any friction between the mating features. The installer may now utilize tool 2002 or another mechanism to drive bolt 1108 into threaded engagement with threaded nut 1008, thereby developing the necessary mating force to couple all the MMC connectors in unison.

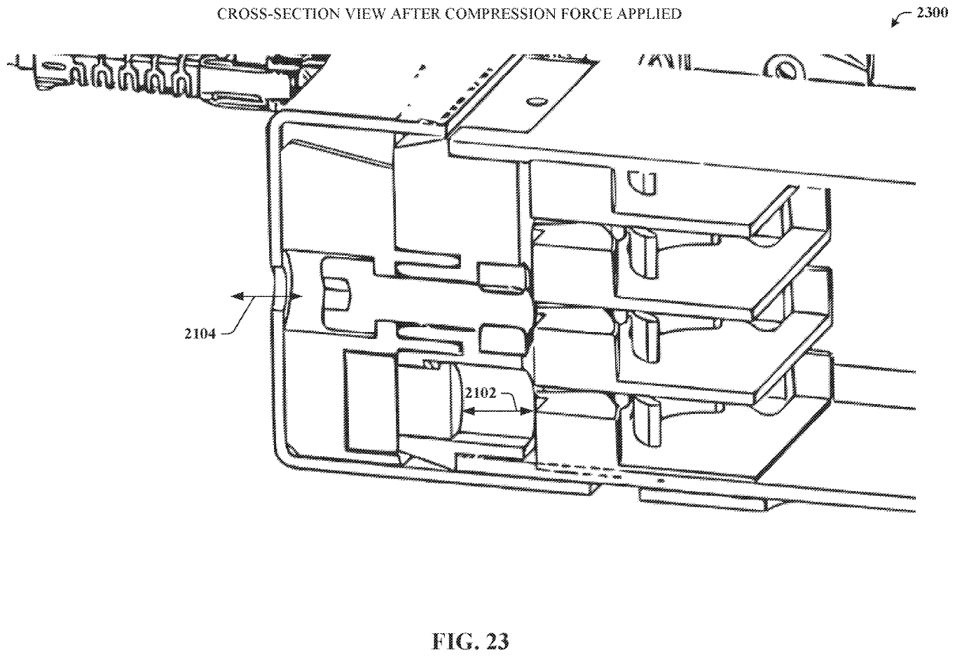

FIG. 23 provides a similar longitudinal cross-section perspective 2300, but after compression has been applied in accordance with various embodiments of this disclosure. As shown, threaded bolt 1108 and threaded nut 1008 can be in full engagement, and magnet 1010 may lie flush (or nearly flush) with the front face plane of GCA 1000. Once tool 2002 is operated to tighten bolt 1108 against nut 1008, the total axial force can bring each MMC connector 1002 into full mating with its counterpart 1102. By allowing magnet 1010 to retract in line with reference line 2102, and permitting bolt 1108 to move along reference line 2104, these components can adapt to small positioning differences or tolerances during final tightening. This configuration may help minimize the risk of damage to delicate fiber interfaces and can streamline the final step of connecting a high-density cable array in large or challenging cabinet environments.

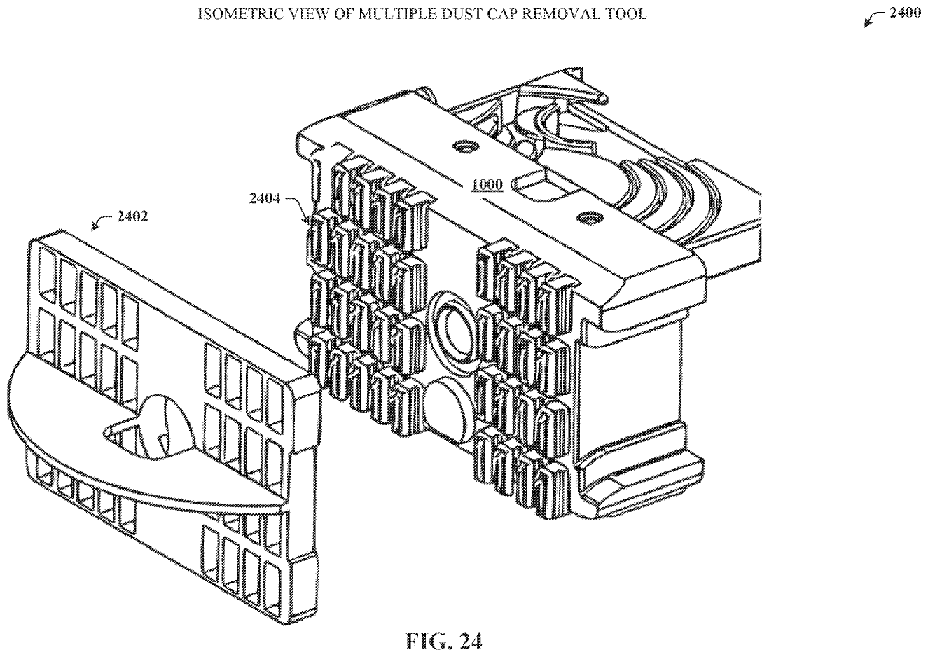

In addition to the advantages provided by the various alignment elements described above (e.g., magnet 1010 and corresponding magnetic responsive material 1110, tenon 1106 and corresponding mortise 1006, threaded nut 1008 and corresponding threaded bolt 1108, wing(s) 1104 and corresponding recess(es) 1004, slotted tray 1502 and corresponding T-members 1602, . . . ), the disclosed subject matter can further provide elements relating to facilitating a factory-clean installation process. In that regard, the disclosed subject matter can include improved dust caps and a tool for removing multiple dust caps in unison, which can operate to increase the speed of installation and mitigate contamination of the fibers during installation, which are further detailed in connection with FIGS. 24-27 and which can now be considered together in combination.

### Example Specialized Dust Caps and Removal Tool

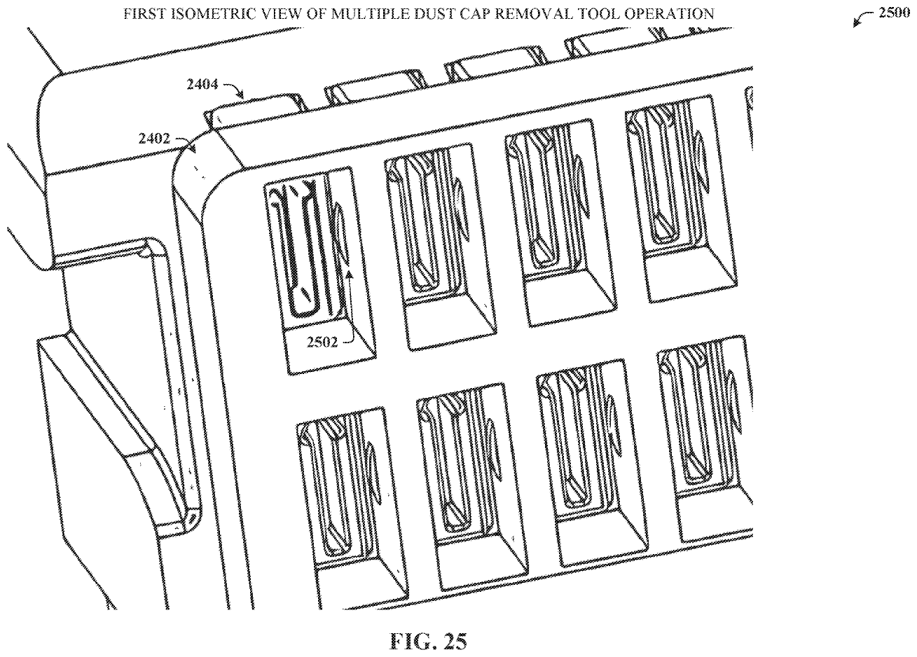

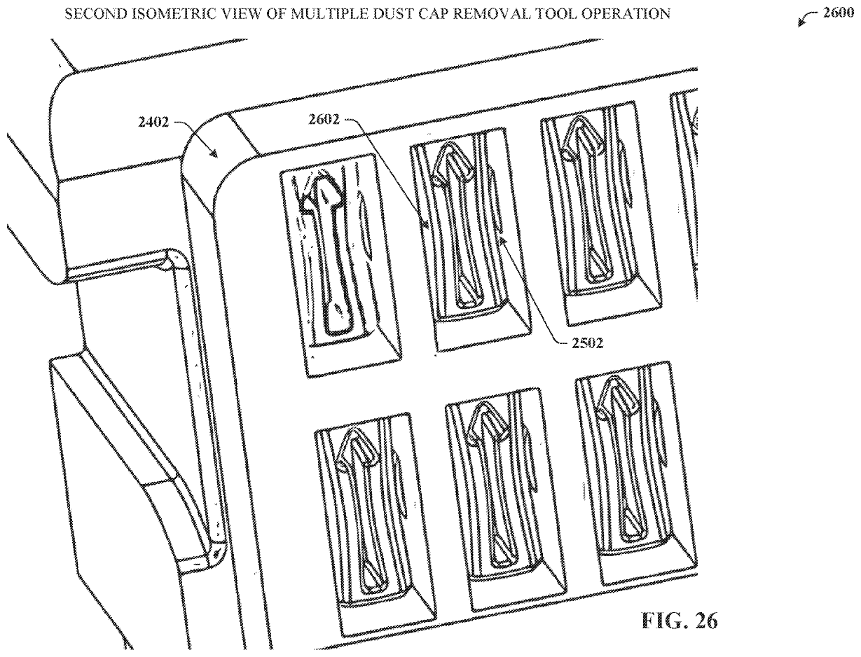

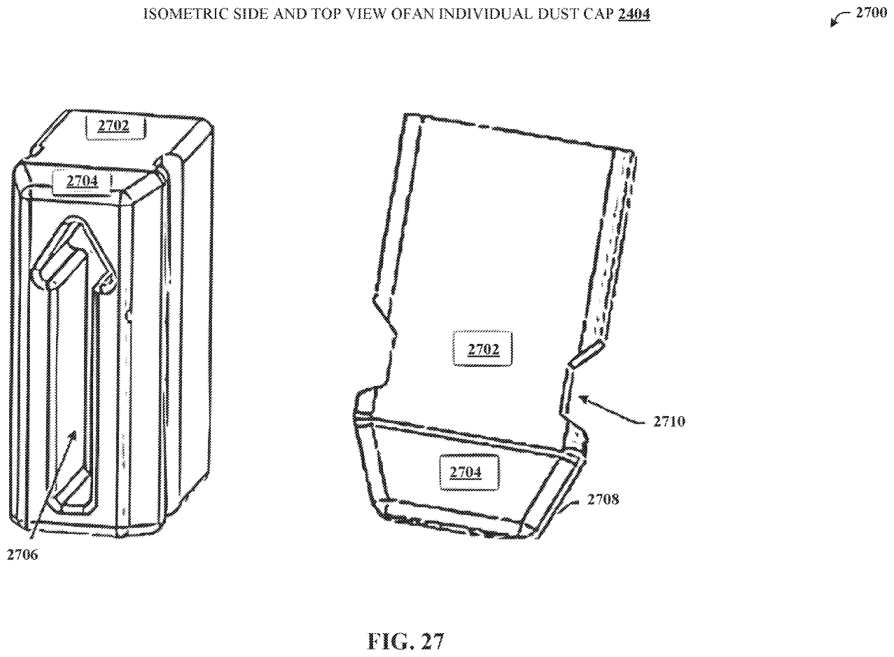

FIG. 24 illustrates an example isometric view 2400 of an example multiple dust cap removal tool 2402 and associated dust caps 2404 in accordance with various embodiments of this disclosure. FIG. 25 illustrates a first example isometric view 2500 of the example multiple dust cap removal tool 2402 in operation just prior to engaging with the dust caps 2404 in accordance with various embodiments of this disclosure. FIG. 26 illustrates a second example isometric view 2600 of the example multiple dust cap removal tool 2402 in operation just after engaging with the dust caps 2404 causing deformation 2602 to the dust caps 2404 thereby facilitating transition of the detents 2502 in accordance with various embodiments of this disclosure. FIG. 27 illustrates an isometric side and top view 2700 on an individual dust cap 2404 showing advantageous geometry in accordance with various embodiments of this disclosure.

In more detail, FIG. 24 depicts the isometric view 2400 of a multiple dust cap removal tool 2402 that can be employed in conjunction with specialized dust caps 2404 to help maintain a factory-clean installation. In many cases, a group of fiber ferrules (for instance, MMC connectors 1002, 1102) can be cleaned at the manufacturing facility after being deployed in a ganged connector arrangement (e.g., GCA 1000 or CGCA 1100). Following the cleaning process, each connector ferrule can be fitted with an individual dust cap 2404 to keep the fiber surfaces free from airborne contaminants or incidental contact. The removal tool 2402 can be placed over the dust caps 2404 before shipping to the customer so that, when at the customer site, the installer may remove all dust caps 2404 in a single action rather than detaching each cap individually. This can reduce the overall exposure time of the cleaned connectors and help mitigate the risk of re-contamination in addition to expediting and simplifying the installation process.

FIG. 25 illustrates a first example isometric view 2500 of the multiple dust cap removal tool 2402 being positioned just before engaging dust caps 2404. Each slot within the body of tool 2402 may include detents 2502 on opposing walls. As the tool 2402 is brought into contact with the dust caps 2404, the detents 2502 can slide along surfaces of the dust caps 2404. Because the dust caps are still attached to the connectors on GCA 1000 (or CGCA 1100), the removal tool 2402 can effectively snap onto them. This action can provide a one-step approach to prepare the connectors for mating: once the removal tool is in place, the removal tool can be pulled away (or otherwise actuated), thereby removing each dust cap 2404 simultaneously or concurrently.

FIG. 26 shows a second example isometric view 2600 where the removal tool 2402 has advanced just enough for the detents 2502 to contact and deform a flexible crown portion of each dust cap (an example of this deformation is denoted at 2602). As the detents 2502 clear the apex of the dust cap's crown, they may snap into a corresponding recess in the dust cap's base (further detailed in connection with FIG. 27), thereby securing each dust cap 2404 to the removal tool 2402. By forming this temporary lock, an operator can simply retract the removal tool 2402 and remove all dust caps 2404 in unison. This multi-cap removal process can significantly decrease total installation time while reducing the amount of time each individual connector is exposed.

FIG. 27 provides an isometric side and top view 2700 of an individual dust cap 2404. The illustrated dust cap 2404 can include a base 2702 and a crown 2704. The crown 2704 may taper or ramp near its tip to facilitate smooth engagement by the detents on removal tool 2402, an aspect indicated by tapered or ramped portions 2708. The dust cap base 2702 can include a shaped recess 2710 that matches the contour of each detent 2502, allowing the detent to seat securely once the crown 2704 has been deformed enough to let the detent pass. The side view further illustrates an arrow graphic on the crown 2704 that points upward to convey proper orientation during installation or removal. In various embodiments, this arrow shape can be formed by removing material from dust cap 2404.

Typically, the depth of the arrow-shaped hole is quite shallow. However, in accordance with the disclosed subject matter, this arrow-shaped hole can be constructed by boring completely through the crown 2704, which is illustrated at reference numeral 2706. Such construction can create a pronounced through-opening rather than a superficial marking. This deeper opening can make the orientation marking more visible, can add beneficial flexibility to the crown portion, and can reduce material costs for the dust caps 2404. Consequently, an installer can quickly discern the correct orientation for placing or removing each dust cap 2404, and the dust cap 2404 can exhibit improved compliance that can ease the snap-on/snap-off process when employed with a multi-cap removal tool 2402. Advantageously, dust cap 2404 can be composed of silicon, which is both flexible and has anti-dust or other contaminant and anti-static properties. Multi-cap removal tool 2402 can be composed of a rigid material such as plastic.

In view of the above discussion relating to the multi-cap removal tool 2402 and associated dust caps 2404, it can be readily appreciated that removal of the factory-installed dust caps 2404 should be performed as near as possible to the achieving of the aligned state between GCA 1000 and CGCA 1100. One difficulty associated therewith is that one or the other of the ganged connectors is typically mounted at the front of the cabinet, while the other is threaded through the interior of the cabinet from the back of the cabinet. Typically, the cabinets accumulate significant amounts of dust or other contaminants over time and a given installation process can potentially agitate the accumulated dust, launching the dust to an airborne state.

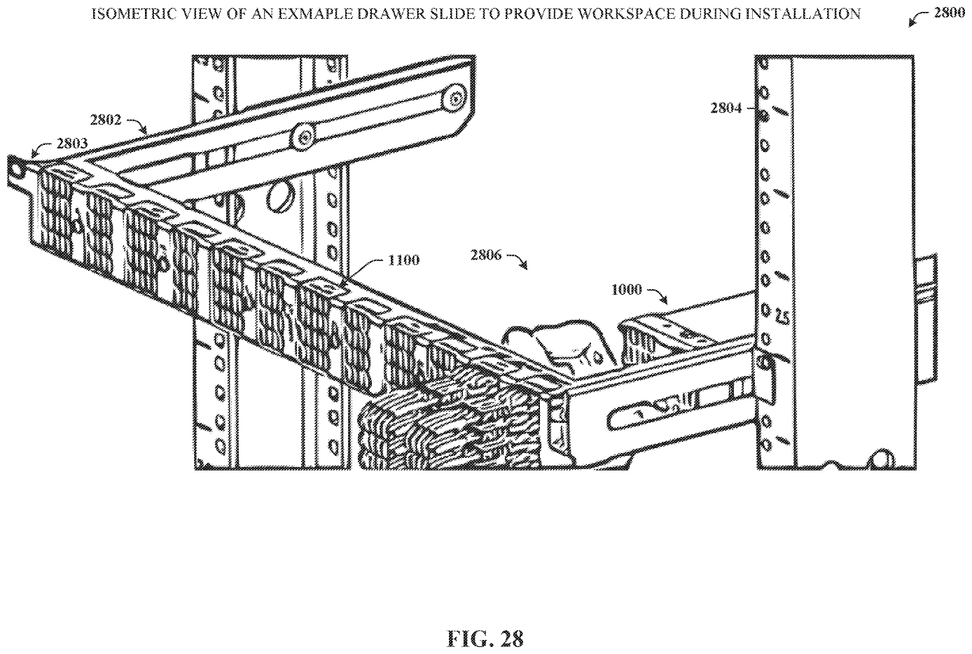

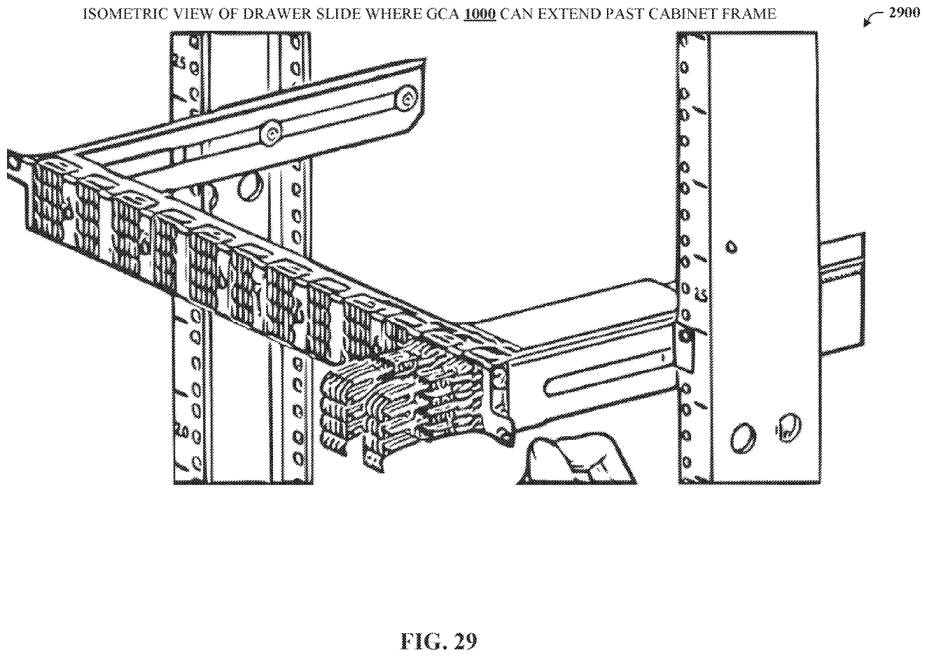

Hence, it can be beneficial to delay the removal of dust caps until after the ganged connectors have been threaded through the cabinet (e.g., just prior to achieving the aligned state. To these and other ends, the frame structure of the cabinet or other elements associated with slotted tray 1502 can be improved such as with a specially designed drawer slide, examples of which are detailed in connection with FIGS. 28 and 29.

### Example Drawer Slide and Associated Elements

In that regard, FIG. 28 illustrates an example isometric view 2800 of an example drawer slide 2802 that can facilitate targeted workspace 2806 for an installer in accordance with various embodiments of this disclosure. FIG. 29 illustrates an example isometric view 2900 of the example drawer slide 2802 that can facilitate sliding GCA 1000 beyond the frame 2804 of the cabinet in accordance with various embodiments of this disclosure.

FIG. 28 illustrates an example isometric view 2800 in which a cabinet frame 2804 and associated drawer slide mechanism 2802 can house one or more CGCAs 1100 and a GCA 1000 that has been threaded through the interior of the cabinet. A rail 2803 and drawer slide mechanism 2802 are shown extended outward from the frame 2804 by several inches (for instance, six inches to about a foot), creating a targeted workspace 2806 at the front of the cabinet. This target workspace 2806 can offer an installer enough clearance to easily manipulate the front-facing components of either or both GCA 1000 and CGCA 1100.

For example, target workspace 2806 can be utilized when removing the factory-assembled multiple dust cap removal tool 2402 (carrying dust caps 2404) or making final alignment checks. One of the core challenges in deep cabinets is that ganged connectors are frequently seated flush or recessed within the cabinet, forcing technicians to work in a cramped or obstructed space. By permitting the rail 2803 to slide the CGCAs 1100 outward, the targeted workspace 2806 alleviates the difficulty of working blindly or at uncomfortable angles. This can be especially helpful to keep connectors factory-clean, as the dust caps 2404 can remain in place until GCA 1000 has been fully routed and then be removed quickly for both GCA 1000 and CGCA 1100 in the more spacious, and potentially cleaner, environment.

FIG. 29 shows a variant of the same concept in which GCA 1000 can move further beyond the frame 2804 of the cabinet rather than stopping flush with it. In some embodiments, the entire rail 2803 and/or drawer slide system 2802 may allow the ganged connectors to extend significantly out of the cabinet, providing more robust access to the connectors, alignment elements, and any dust cap removal tools. Depending on the installation or maintenance requirements, this design can be used in tandem with the slotted tray 1502 or in lieu of it.

In one scenario, an installer might rely on T-members 1602 and the tray slot 1504 of slotted tray 1502 for accomplishing the initial blind feed from the rear, then slide the rail 2803 forward once GCA 1000 reaches the front region and dust caps 2404 and tool 2402 have been removed. In another scenario, a cabinet design could omit the tray entirely and rely solely on the drawer slide 2802 to bring the connectors from deep within the enclosure out into a more spacious work area 2806. Either approach can mitigate the risk of contaminating or damaging the connectors by reducing the number of times the installer must blindly reach into the cabinet.

### Example Patch Panel Retention and Cabinet Support Elements

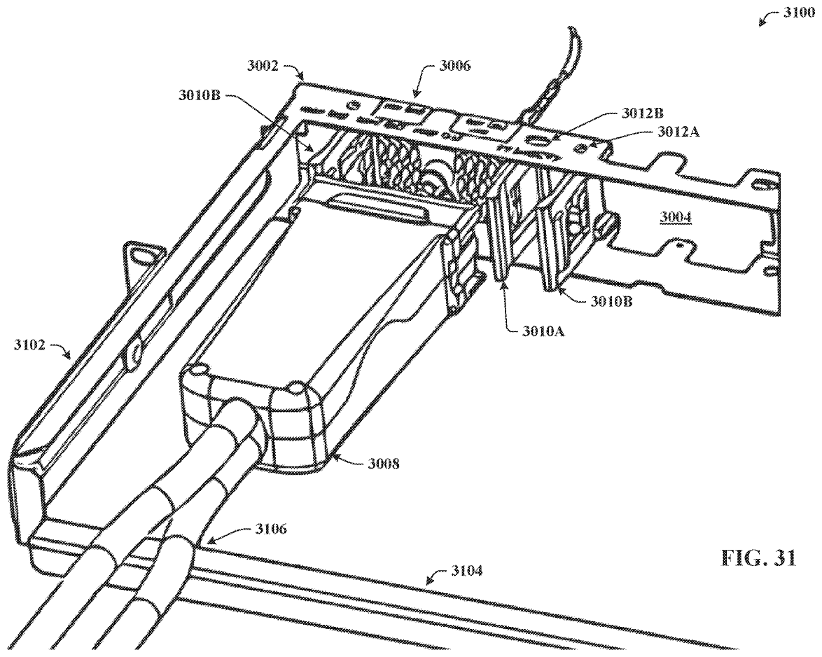

With reference now to FIGS. 30 and 31, FIG. 30 depicts a first isometric view of an example patch panel assembly 3000 comprising a latching mechanism that facilitates retaining or releasing either one or both interfaced ganged connectors in accordance with various embodiments of this disclosure. FIG. 31 depicts a second isometric view of the example patch panel assembly 3100 comprising the latching mechanism that facilitates retaining or releasing either one or both interfaced ganged connectors in accordance with various embodiments of this disclosure.

Patch panel assembly 3000, 3100 can comprise patch panel frame 3002 that can be commonly associated with a rack unit of a data cabinet in a data center environment or the like. Hence, patch panel assembly 3000 can serve as an interface and mating point for two ganged connectors such as GCA 100, 1000 and CGCA 300, 1100. In this illustration, patch panel assembly 3000, 3100 comprises aperture 3004, which can receive ganged connector (GC) module 3006 from a front side 3014 of patch panel assembly 3000 and can receive GC module 3008 from a rear side 3016 of patch panel assembly 3000. In this example, front GC module 3006 is exemplified by CGCA 1100 and rear GC 3008 module is exemplified by GCA 1000, but it is appreciated that any mating GC modules can be used according to any suitable orientation.

In some embodiments, the aforementioned latching mechanism can take the form of dual GC brackets 3010, which are further illustrated in FIG. 31 as individual brackets 3010A and 3010B that are respectively positioned at opposing lateral sides of aperture 3004. As shown in FIG. 30, reference line 3018 illustrates a lateral direction (e.g., an axis that spans patch panel assembly 3000, 3100) and reference line 3020 illustrates an axial direction (e.g., a direction, either front or rear in which GC modules 3006, 3008 are inserted into aperture 3004).

In some embodiments, dual GC brackets 3010 can be configured as a patch panel retention insert 3200 as further detailed in connection with FIGS. 32-35B. Hence, in some embodiments, GC brackets 3010A, 3010B can be identically or similarly designed or formed with respect to one another, which can reduce part numbers and manufacturing costs. However, even though GC bracket 3010A can be substantially the same as GC bracket 3010B, the two can exist within patch panel assembly 3000, 3100 according to different orientations. Patch panel frame 3002 can have cutouts 3012 that allow for insertable retention of GC brackets 3010. As further illustrated in FIG. 31, cutout 3012A can have a different shape or design than cutout 3012B, so that during installation or forming of GC brackets 3010, each can be properly aligned for retention of GC modules 3006, 3008.

With specific reference to FIG. 31, in some embodiments, patch panel assembly 3100 can be situated on a drawer slide mechanism 3102. Drawer slide mechanism can be configured to allow patch panel assembly 3100 to glide into and out of a data cabinet (not shown). Drawer slide mechanism 3102 can comprise rear beam structure 3104. Rear beam structure 3104 can be configured to support trunk cabling attached to the rear GC module 3008, as illustrated by reference numeral 3106.

In operation, patch panel assembly 3000 can facilitate bidirectional access to a shared connection interface using two independent ganged connector modules, which can be inserted from opposite axial directions (e.g., front side 3014 and rear side 3016). Each of these GC modules 3006, 3008 can be retained within aperture 3004 by the cooperative action of the dual GC brackets 3010A, 3010B. Because GC brackets 3010 can be laterally situated (e.g., on opposing sides of the aperture 3004 along lateral direction 3018), the retention mechanism can be symmetric with respect to axial direction 3020 and can enable both GC modules 3006, 3008 to be latched or unlatched independently from either side of the patch panel assembly 3000, 3100.

Notably, this design permits a modular and non-permanent coupling approach that reduces installation complexity. The GC brackets 3010A, 3010B can each include distinct cantilevered features (e.g., as further shown in FIGS. 32-35B) that are offset vertically or laterally to respectively engage the front-side and rear-side GC modules 3006, 3008. As such, both the front GC module 3006 and rear GC module 3008 can share mechanical engagement surfaces on the same pair of brackets 3010 without interference. This dual-sided retention capability, while using a shared bracket profile, can reduce part count and streamline assembly workflows in manufacturing.

Furthermore, this approach can facilitate single-technician servicing operations. For instance, the ability to independently unseat and remove either GC module 3006, 3008, while leaving the other GC module 3006, 3008 in place, can enable access to one side of the connection interface for inspection, cleaning, or replacement without disrupting the full link path. In contrast to patch panels that require rear access from behind a cabinet frame or simultaneous removal of a bulk housing, this configuration supports localized disengagement and rapid re-engagement of connectors with minimal displacement of other system components.

When integrated with drawer slide mechanism 3102, which is optionally coupled to rear beam structure 3104, the patch panel assembly 3000, 3100 can be partially or fully extended from a rackmount frame to improve access. The rear beam structure 3104 can offload gravitational and torsional stresses that would otherwise be borne by the GC components or patch panel components, thereby protecting the mechanical interface and improving cable strain relief. This can be particularly beneficial in high-density installations involving heavy trunk cables or blind mating procedures.

Furthermore, it is to be appreciated that although patch panel assembly 3000 3100 is depicted in a horizontal orientation consistent with standard rack units, the disclosed subject matter can be applied to vertically oriented cable trays, rear-access service panels, or other frame configurations supporting axial insertion of GC module 3006 and GC module 3008.

### Example Patch Panel Inserts

FIG. 32 depicts an orthographic side view of an example patch panel retention insert 3200 configured to be inserted into a patch panel frame 3002 to provide the GC bracket 3010 functionality in accordance with various embodiments of this disclosure. As illustrated, patch panel retention insert 3200 can comprise first cantilevered tab 3202 and second cantilevered tab 3204. First cantilevered tab 3202 can be configured to engage front GC module 3006 after front GC module 3006 has been inserted into aperture 3004 sufficient to reach a seated position for coupling to rear GC module 3008. Second cantilevered tab 3204 can be configured to engage rear GC module 3008 after rear GC module 3008 has been inserted into aperture 3004 and reaches a seated position for coupling to front GC module 3006. Each cantilevered tab 3202, 3204 can retain its corresponding GC module 3006, 3008 within patch panel assembly 3000 or 3100 without requiring permanent fixation or specific tool-based installation, such that GC module 3006 and GC module 3008 can be individually removed and replaced as needed.

Cantilevered tabs 3202 and 3204 can each include one or more protrusion elements configured to engage corresponding recesses formed on GC module 3006 and GC module 3008. As illustrated, first cantilevered tab 3202 can comprise protrusion element 3208A and second cantilevered tab 3204 can comprise protrusion element 3208B. Protrusion element 3208A can be configured to snap into recess 1112 on GC module 3006 (e.g., wing 1104) and protrusion element 3208B can be configured to snap into recess 1012 on GC module 3008. This arrangement can operate as a snap-fit latching mechanism that can retain each GC module during normal operation and can permit disengagement via a lateral force applied to the associated cantilevered tab. Such lateral force can be delivered manually or using a simple tool, allowing for efficient field servicing.

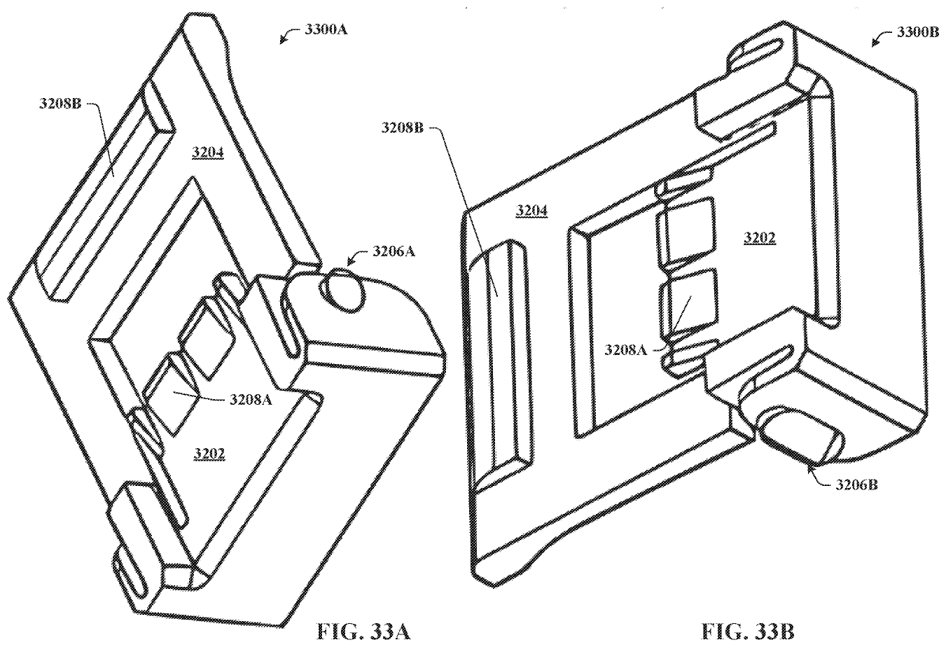

Patch panel retention insert 3200 can further comprise top post 3206A and bottom post 3206B. Top post 3206A can be located at a top end of patch panel retention insert 3200, and bottom post 3206B can be located at a bottom end of patch panel retention insert 3200. Top post 3206A and bottom post 3206B can be configured to mate with respective cutouts 3012A and 3012B of patch panel frame 3002. In some embodiments, top post 3206A and bottom post 3206B can have distinct geometries. For example, top post 3206A can be cylindrical while bottom post 3206B can be oval-shaped or elliptical. This difference in geometry is better illustrated in FIGS. 33A and 33B and can prevent incorrect insertion of patch panel retention insert 3200 into patch panel frame 3002, such that a technician can only install patch panel retention insert 3200 in its correct vertical orientation. This keyed configuration can reduce installation errors, enforce consistent alignment between GC module 3006 and GC module 3008, and improve mechanical reliability during use.

Turning now to FIGS. 33A and 33B, depicted are different isometric views 3300A and 3300B of the example patch panel retention insert 3200 that is configured to be inserted into a patch panel frame 3002 to provide latching or unlatching of GC modules 3006, 3008 in accordance with various embodiments of this disclosure. For example, FIG. 33A shows a perspective view 3300A of patch panel retention insert 3200 from an exterior angle that emphasizes cantilevered tab geometries and post features. FIG. 33B shows perspective view 3300B from an alternative orientation that reveals internal structural support elements and clearer alignment of the protrusion features.

In both views, protrusion element 3208A on first cantilevered tab 3202 and protrusion element 3208B on second cantilevered tab 3204 are shown in greater detail. These protrusion elements can have a raised profile that can exert a spring-biased engagement force into their respective recesses during installation. This profile can be tapered to facilitate guided insertion and can provide a tactile and/or audible click to confirm engagement. The protrusion shape can vary based on the connector type, housing compliance, or environmental usage conditions. In some embodiments, protrusion elements 3208A and 3208B can be interchangeable or symmetrically formed to simplify part production.

Additionally, top post 3206A and bottom post 3206B are more clearly illustrated in FIGS. 33A and 33B. As shown, top post 3206A can have a circular or substantially round cross-section, and bottom post 3206B can have an elliptical or oval-shaped cross-section. These shapes can correspond directly to uniquely-shaped cutouts 3012A and 3012B of patch panel frame 3002. This asymmetric geometry can operate as a mechanical key that enforces a single permissible insertion orientation for patch panel retention insert 3200, which can further ensure that cantilevered tabs 3202 and 3204 align with front GC module 3006 and rear GC module 3008, respectively. In this manner, the keyed post structure can facilitate reliable, error-resistant installation in manufacturing or field environments.

Collectively, the elements depicted in FIG. 32 and FIGS. 33A and 33B can form a modular, mechanically robust, and field-serviceable interface mechanism that supports axial insertion of GC module 3006 and GC module 3008 into a common aperture 3004 while leveraging shared lateral retention structures. These features can reduce assembly steps, eliminate the need for independent fasteners, and support rapid reconfiguration of patch panel assembly 3000, 3100 in high-density cabling environments.

In some embodiments, first cantilevered tab 3202 and second cantilevered tab 3204 can be configured to independently engage and release GC module 3006 and GC module 3008, respectively. In these implementations, each tab can respond separately to a localized lateral force, such that unlatching one GC module does not affect the other. In other embodiments, patch panel retention insert 3200 can comprise a torsional bridge or coupling structure that mechanically links first cantilevered tab 3202 and second cantilevered tab 3204. For instance, a torsional beam can extend between the two cantilevered tabs and can transmit rotational energy between them. As a result, a force applied to first cantilevered tab 3202 can cause second cantilevered tab 3204 to also move, and vice versa. This configuration can enable simultaneous unlocking of GC module 3006 and GC module 3008 through a single action, such as spreading or squeezing both cantilevered tabs or twisting a shared actuator. Such an arrangement can simplify removal procedures and can be advantageous in constrained environments where direct access to both sides of patch panel assembly 3000, 3100 may be infeasible or may not be readily available.

In some embodiments, patch panel retention insert 3200, including first cantilevered tab 3202 and second cantilevered tab 3204, can be formed from a polymeric or composite material selected to provide a balance between structural rigidity and elastic compliance. Suitable materials can include in some embodiments glass-filled polycarbonate, polyetheretherketone (PEEK), acrylonitrile butadiene styrene (ABS), or high-density polyethylene (HDPE). These materials can be selected based on their flexural modulus, impact resistance, and resistance to deformation under repeated cycling. In one example, patch panel retention insert 3200 can be injection-molded using a 30% glass-filled polycarbonate blend, which can offer consistent snap-fit behavior and dimensional stability over a temperature range of approximately −20 °C to 60 °C.

In some embodiments, protrusion element 3208A and protrusion element 3208B can be designed to provide a spring force sufficient to retain front GC module 3006 and rear GC module 3008 with an insertion or extraction force of any suitable range. For example, one suitable range may be deemed to be in the range of approximately 3 to 8 lbf (13 to 35 N), though other values are contemplated depending on connector type, housing surface finish, or other suitable parameters. In some implementations, patch panel retention insert 3200 can be tested to withstand more than X (e.g., X can equal about 100, 500, . . . ) insertion/removal cycles without loss of retention force or permanent deformation of cantilevered tab 3202 or cantilevered tab 3204.

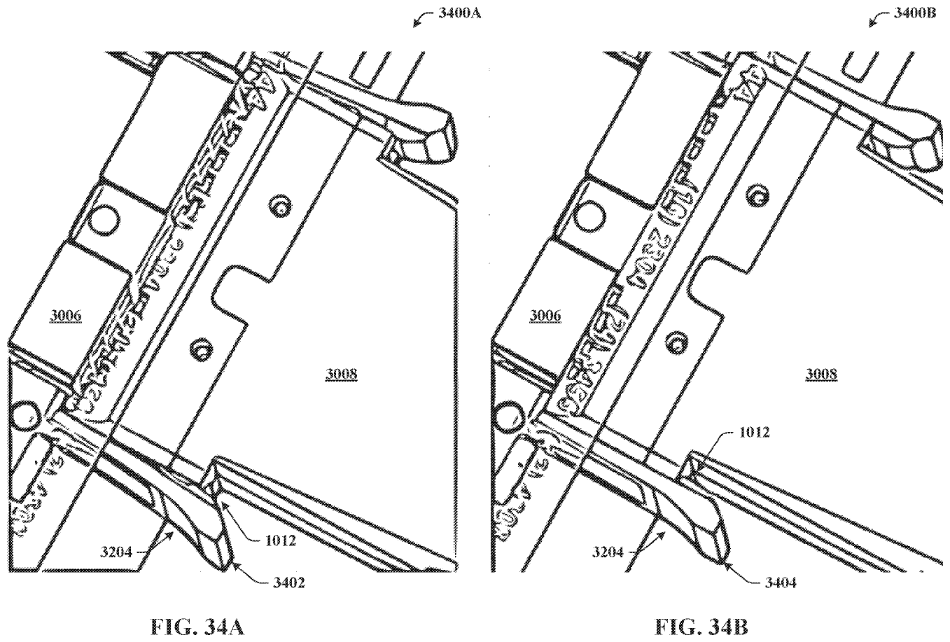

With reference now to FIGS. 34A and 34B, respective isometric views 3400A and 3400B are illustrated showing two distinct states of the second cantilevered tab 3204 of the GC bracket 3010 as the rear GC module 3008 transitions to the locked or latched state in accordance with various embodiments of this disclosure. In this depiction, front GC module 3006 is already seated in aperture 3004, such that front GC module 3006 is latched in place via engagement between first cantilevered tab 3202 and front GC module 3006. Rear GC module 3008 is shown in the process of being installed from the rear side 3016 of patch panel assembly 3000.

In FIG. 34A, rear GC module 3008 is translated forward toward aperture 3004, and protrusion element 3208B of second cantilevered tab 3204 makes contact with an outer housing surface of rear GC module 3008. As rear GC module 3008 continues to advance, this contact causes second cantilevered tab 3204 to temporarily flex outward, as illustrated by arrow 3402. The flexure shown at arrow 3402 can correspond to elastic deformation of second cantilevered tab 3204 that is reversible upon seating of rear GC module 3008. This deformation can allow protrusion element 3208B to bypass the exterior of rear GC module 3008 without substantial resistance or damage.

In FIG. 34B, rear GC module 3008 is shown having reached a seated position within aperture 3004. In this state, second cantilevered tab 3204 has returned to a relaxed position, and protrusion element 3208B has entered and engaged with recess 1012 of rear GC module 3008, as indicated by reference numeral 3404. This snap-fit engagement can represent the locked or latched state in which rear GC module 3008 is retained within patch panel assembly 3000 by second cantilevered tab 3204. This engagement can provide both tactile and mechanical feedback that confirms seating, and can further provide resistance to axial displacement or decoupling during operation or handling.

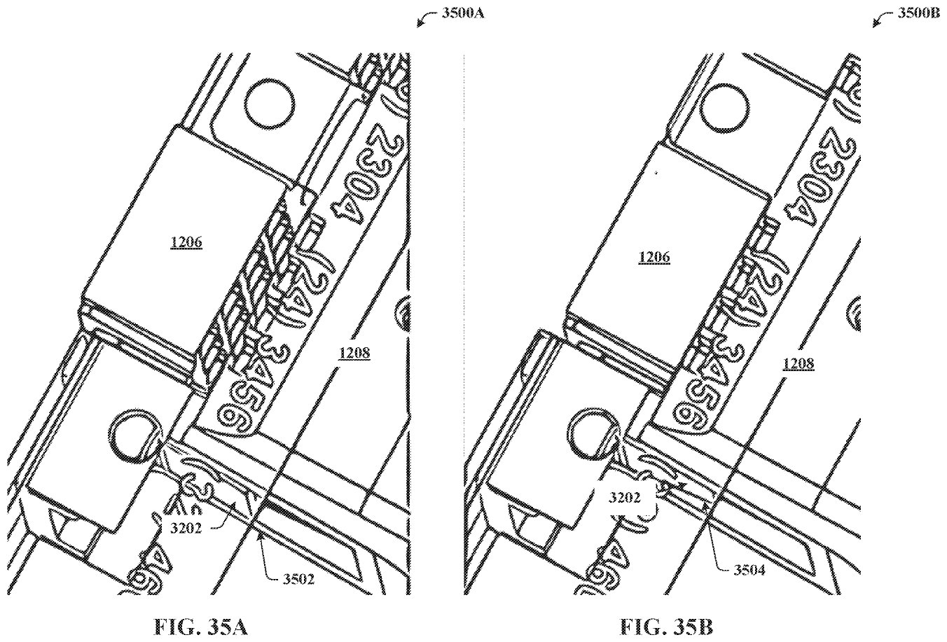

Turning now to FIGS. 35A and 35B, respective isometric views 3500A and 3500B are illustrated showing two distinct states of the first cantilevered tab 3202 of the GC bracket 3010 as the front GC module 3006 transitions to the locked or latched state in accordance with various embodiments of this disclosure. In this example, rear GC module 3008 is already seated in aperture 3004 and retained by second cantilevered tab 3204. Front GC module 3006 is inserted from front side 3014 and approaches rear GC module 3008 for alignment and coupling.

In FIG. 35A, protrusion element 3208A of first cantilevered tab 3202 makes initial contact with a surface of front GC module 3006. As front GC module 3006 advances axially, the interaction between protrusion element 3208A and the outer housing of front GC module 3006 (or in this example, wing 1104) can cause first cantilevered tab 3202 to flex laterally outward, as shown by reference numeral 3502. This deflected state enables the continued travel of front GC module 3006 toward rear GC module 3008 without obstruction.

In FIG. 35B, front GC module 3006 has completed insertion into aperture 3004 and is seated for coupling with rear GC module 3008. At this stage, first cantilevered tab 3202 has returned to a rest position as indicated at reference numeral 3504, and protrusion element 3208A is now engaged in recess 1112 (not shown in this particular view) of front GC module 3006. This configuration represents a latched state in which front GC module 3006 is retained against forward or backward axial motion, securing its position within patch panel assembly 3000.

Collectively, the elements depicted in FIGS. 34A through 35B illustrate a dual-sided snap-fit engagement process wherein front GC module 3006 and rear GC module 3008 can be independently inserted and latched into patch panel assembly 3000 from opposite sides. The illustrated flexing and return behaviors of first cantilevered tab 3202 and second cantilevered tab 3204 demonstrate that each GC module can be installed without requiring access to the opposite side or the use of tools, thereby simplifying deployment and service.

### Example Methods

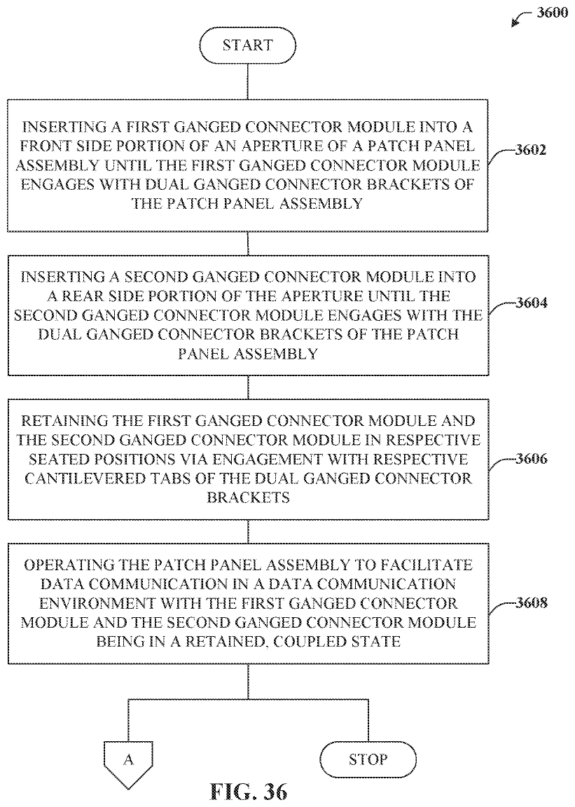

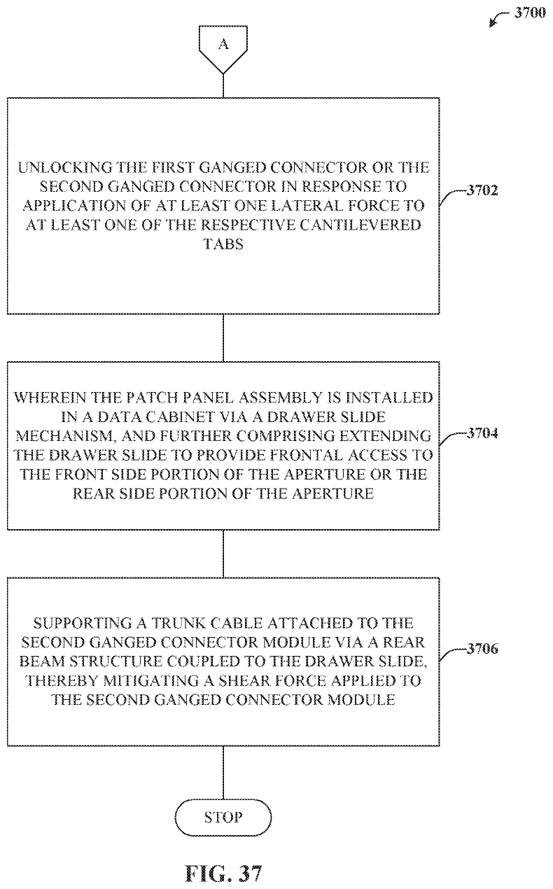

FIGS. 36 and 37 illustrate various methods in accordance with the disclosed subject matter. While, for purposes of simplicity of explanation, the methods are shown and described as a series of acts, it is to be understood and appreciated that the disclosed subject matter is not limited by the order of acts, as some acts may occur in different orders and/or concurrently with other acts from that shown and described herein. For example, those skilled in the art will understand and appreciate that a method could alternatively be represented as a series of interrelated states or events, such as in a state diagram. Moreover, not all illustrated acts may be required to implement a method in accordance with the disclosed subject matter.

Referring now to FIG. 36, exemplary method 3600 is depicted. Method 3600 depicts an example flow diagram representing a process for insertion and retention of GC modules with respect to a patch panel assembly in accordance with various embodiments of this disclosure. While method 3600 describes a complete method, in some embodiments, method 3600 can include one or more elements of method 3700, as illustrated by insert A.

At reference numeral 3602, a first ganged connector module can be inserted into a front side portion of an aperture of a patch panel assembly until the first ganged connector module engages with dual ganged connector brackets of the patch panel assembly.

At reference numeral 3604, a second ganged connector module can be inserted into a rear side portion of the aperture until the second ganged connector module engages with the dual ganged connector brackets of the patch panel assembly.

At reference numeral 3606, the first ganged connector module and the second ganged connector module can be retained in respective seated positions via engagement with respective cantilevered tabs of the dual ganged connector brackets.

At reference numeral 3608, the patch panel assembly can be operated to facilitate data communication in a data communication environment with the first ganged connector module and the second ganged connector module being in a retained, coupled state. Method 3600 can terminate or continue to insert A, which is further detailed in connection with FIG. 37.

Turning now to FIG. 37, exemplary method 3700 is depicted. Method 3700 provides an example flow diagram representing additional aspects or elements of the process for insertion and retention of GC modules with respect to a patch panel assembly in accordance with various embodiments of this disclosure.

At reference numeral 3702, the first ganged connector or the second ganged connector can be unlocked in response to application of at least one lateral force to at least one of the respective cantilevered tabs.

At reference numeral 3704, the patch panel assembly can be installed in a data cabinet via a drawer slide mechanism. In accordance therewith, method 3700 can further comprise extending the drawer slide to provide frontal access to the front side portion of the aperture or the rear side portion of the aperture.

At reference numeral 3706, method 3700 can further comprise supporting a trunk cable attached to the second ganged connector module via a rear beam structure coupled to the drawer slide, thereby mitigating a shear force applied to the second ganged connector module.

### Example Rear Cable Management and Internal Routing

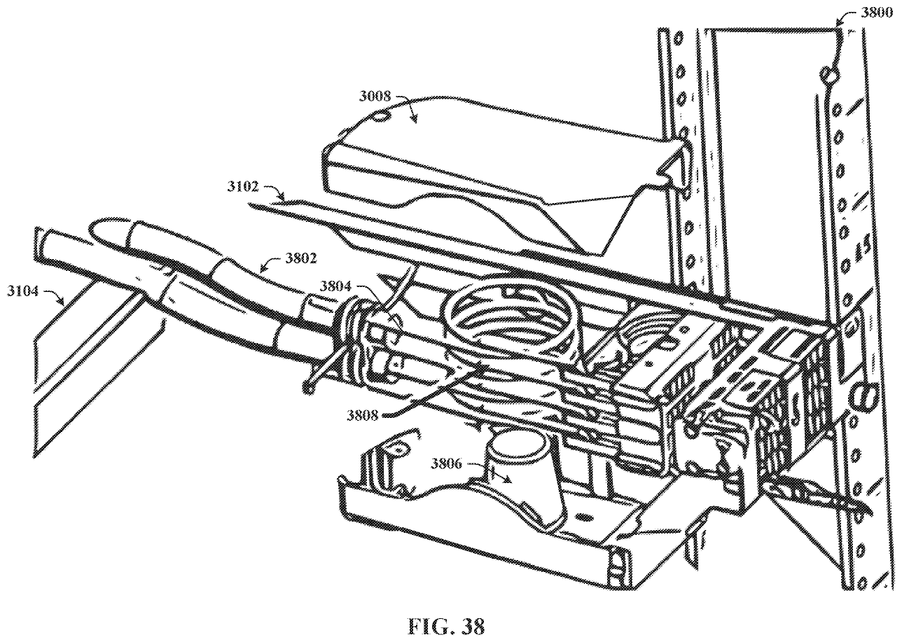

With reference now to FIG. 38, an exploded isometric view 3800 is illustrated showing additional detail of rear GC module 3008 and associated internal cable management via spool 3806 in accordance with various embodiments of this disclosure. As shown, trunk cables 3802 can extend into rear GC module 3008 from the rear side 3016 and can be supported by rear beam structure 3104, similar to the configuration shown in FIG. 31. Trunk cables 3802 can comprise bundled optical fiber cables terminated at rear GC module 3008, which, in this example, is illustrated in an exploded state to reveal internal routing and breakout structures.

Within rear GC module 3008, each trunk cable 3802 can include a plurality of optical fibers that are separated internally into a corresponding group of individual connector cables 3804. In some embodiments, individual connector cables 3804 can be buffered or jacketed optical fiber cables that are designed to terminate at a specific optical connector such as connector 306 (described with respect to CGCA 300 in FIG. 3) or connector 1102 (described with respect to CGCA 1100 in FIG. 11). These individual connector cables 3804 can be routed internally from the point of trunk breakout to the front face of rear GC module 3008, where each individual connector cable 3804 can terminate into a respective aperture or housing configured to support the ganged connector interface.

To manage the physical routing of individual connector cables 3804 and to prevent the fibers from experiencing excessive curvature or mechanical stress, spool 3806 can be provided as an internal support structure within rear GC module 3008. Spool 3806 is depicted as a conical frustrum in FIG. 38, but in other embodiments, spool 3806 can have a cylindrical profile or other profile depending on available space, fiber slack requirements, or preferred manufacturing techniques. Whether conical, cylindrical, or otherwise, spool 3806 can be configured to serve as a cable routing surface that maintains a minimum bend radius for each individual connector cable 3804 as it transitions from trunk cable 3802 to the final termination point.

In operation, individual connector cables 3804 can be routed helically around spool 3806, thereby forming a helix shape 3808 that is shown above spool 3806 due to the exploded nature of the figure. When rear GC module 3008 is fully assembled, spool 3806 can be mechanically coupled to the bottom interior portion of the rear GC module 3008 housing, and helix shape 3808 can correspond to actual routing of the fiber paths around the outer wall of spool 3806. This routing configuration can enable several key benefits.

For example, spool 3806 can ensure that none of the individual connector cables 3804 exceed their specified minimum bend radius, thereby protecting optical transmission performance and reducing the risk of microbending, macrobending, or permanent attenuation loss. As another example, the use of spool 3806 can absorb excess fiber slack that may otherwise crowd the internal cavity of rear GC module 3008, improving internal cable management and manufacturability. Still another example, the helical routing defined by helix shape 3808 can support strain-relief properties by distributing mechanical loading uniformly along the fiber path.

In addition to these benefits, spool 3806 can allow for modularization and repeatable assembly processes. For example, during fabrication, individual connector cables 3804 can be wrapped around spool 3806 in a consistent, template-driven manner and then inserted into rear GC module 3008 as a unit. This can improve yield rates and reduce variability during mass production. The presence of spool 3806 can also facilitate rework or inspection, as spool 3806 can represent an organized structure around which fiber slack is intentionally wound and secured. In some embodiments, spool 3806 can include a peripheral flange or rib to retain individual connector cables 3804 in a specific axial position during assembly or vibration events.

Collectively, the arrangement depicted in FIG. 38 addresses the challenge of transitioning from a high-fiber-count trunk cable 3802 to a precisely terminated set of individual connector cables 3804 within the limited volume of rear GC module 3008. Without a structure like spool 3806, internal fibers might otherwise be bent beyond specification, routed in an uncontrolled manner, be subject to increased failure during installation or handling, or may be more likely to apply additional strain or more delicate parts of the cable path such as the interface with connector housings. The use of spool 3806 as a routing surface with controlled curvature and managed axial slack can maintain signal integrity, support high-density configurations, and reduce operational risk in data center or network switching environments.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

In addition, the term “or” is intended to mean an inclusive “or” rather than an exclusive “or,” akin to the meaning of “and/or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

### ASPECTS

The disclosed subject matter can comprise numerous aspects or embodiments. It is appreciated that aspects described here or above can generally be combined together with any other suitable aspect or combination(s) of aspects, even including combinations not specifically indicated by the below example aspects.

Aspect 1: A ganged connector apparatus, comprising: a housing comprising a group of connectors that are individually configured to couple to a corresponding member of a corresponding group of connectors of a corresponding ganged connector apparatus; a push screw receiver configured to facilitate attaching and securing of the ganged connector apparatus to the corresponding ganged connector apparatus in response to receiving a threaded section of a push screw, of the corresponding ganged connector apparatus, in a direction substantially along a screw axis of the push screw, the push screw receiver comprising a threaded receiver comprising receiver threads configured to mate with screw threads of the threaded section of the push screw; and a receiver pivot that, in response to an axial force applied in the direction by the screw threads in contact with the receiver threads, facilitates rotation of the threaded receiver about a pivot axis, which is substantially perpendicular to the screw axis, wherein the receiver pivot is configured to transition, via the rotation, to an open state in which the threaded receiver is rotated sufficiently to allow the screw threads to clear the receiver threads in response to the axial force applied in the direction.

Aspect 2: The ganged connector apparatus of aspect 1, wherein the threads of the threaded receiver are disposed in a cylindrical chamber that, when mated, surrounds in an arc a portion of the threaded section of the push screw.

Aspect 3: The ganged connector apparatus of aspect 2, wherein the arc is between about 75 degrees and about 120 degrees.

Aspect 4: The ganged connector apparatus of aspect 1, wherein the receiver pivot comprises a spring device that provides a rotation force that is in opposition to the axial force and configured to maintain a closed state in which the threaded receiver is aligned with the push screw when the axial force is less than the rotation force.

Aspect 5: The ganged connector apparatus of aspect 1, wherein at least one receiver thread, of the receiver threads, situated at an entry side of the threaded receiver is tapered to exhibit a shorter height than other members of the receiver threads situated at a back side of the threaded receiver that is opposite the entry side.

Aspect 6: A ganged connector apparatus, comprising: a housing comprising a group of connectors that are individually configured to couple to a corresponding member of a corresponding group of connectors of a corresponding ganged connector apparatus; a push screw configured to facilitate attaching and securing of the ganged connector apparatus to the corresponding ganged connector apparatus, the push screw comprising: a head section that is exposed on a head side of the housing; a shank section that extends through the housing in an axial direction; and a thread section that extends in the axial direction and is exposed on an interface side of the housing that is opposite the head side, wherein the thread section comprises screw threads configured to mate with receiver threads of a threaded receiver of the corresponding ganged connector apparatus, and wherein a first portion of the screw threads are configured to clear a second portion of the receiver threads in response to an axial force applied substantially in the axial direction, resulting in the thread section being axially seated in the threaded receiver; and a crank device configured to rotate the push screw when the thread section is axially seated in the threaded receiver.

Aspect 7: The ganged connector apparatus of aspect 6, wherein the axial force that is sufficient to cause the axial seating is a first axial force, and wherein the first axial force is less than a second axial force that is sufficient to cause the group of connectors to be connected to the corresponding group of connectors.

Aspect 8: The ganged connector apparatus of aspect 7, wherein the crank device, via screw action between the screw threads and the receiver threads when the screw threads are axially seated, provides a third axial force that is greater than or equal to the second axial force.

Aspect 9: The ganged connector apparatus of aspect 8, wherein the crank device is configured to provide the third axial force in response to application of a crank force that is less than the third axial force.

Aspect 10: The ganged connector apparatus of aspect 1 or 6, further comprising an alignment tab situated on the interface side of the housing, wherein the alignment tab is configured to enter an alignment slot of the corresponding connector apparatus, and wherein the alignment tab extends in the axial direction a first distance that is greater than a second distance that the thread section of push screw extends from the housing.

Aspect 11: The ganged connector apparatus of aspect 10, wherein the alignment tab comprises a tapered section that aids in aligning the ganged connector apparatus with the corresponding ganged connector apparatus prior to application of the axial force.

Aspect 12: A ganged connector apparatus (GCA), comprising: a housing comprising a group of connectors that are individually configured to couple to a corresponding member of a corresponding group of connectors of a corresponding GCA (CGCA), the housing comprising an alignment element configured to facilitate an aligned state in which the GCA aligns with the CGCA prior to application of a compression force to connect the group of connectors to the corresponding group of connectors; and a magnetic detent device comprising a magnet configured to magnetically couple, via a magnet force, the GCA to the CGCA prior to attaining the aligned state, wherein the magnetic force operates to aid in achieving the aligned state and to resist subsequent loss of the aligned state.

Aspect 13: The ganged connector apparatus of aspect 12, wherein the alignment element is further configured to be keyed or polarized to prevent misalignment resulting from an improper orientation of the GCA with respect to the CGCA.

Aspect 14: The ganged connector apparatus of aspect 12, wherein the aligned state results from the group of connectors of the GCA being positioned adjacent to the corresponding group of connectors of the CGCA.

Aspect 15: The ganged connector apparatus of aspect 12, wherein the aligned state results from individual members of the group of connectors of the GCA being aligned and in contact with an associated member of the corresponding group of connectors of the CGCA.

Aspect 16: The ganged connector apparatus of aspect 12, wherein the magnet is situated in a chamber configured to permit the magnet to slide in an axial direction that is substantially perpendicular to a front face of the CGA, resulting in the magnet being permitted to protrude beyond the front face of the CGA in order to make contact with the CGCA prior to reaching the aligned state, while being permitted to retract within the chamber in response to the aligned state being reached or in response to the compression force being applied.

Aspect 17: The ganged connector apparatus of aspect 12, further comprising a threaded nut device configured to mate with a threaded bolt device of the CGCA, thereby facilitating the application of the compression force to connect the group of connectors to the corresponding group of connectors.

Aspect 18: The ganged connector apparatus of aspect 17, wherein the threaded nut device is situated in a chamber configured to permit the threaded nut device to slide in an axial direction that is substantially perpendicular to a front face of the CGA to aid in achieving the aligned state regardless of a state of the threaded bolt device of the CGCA.

Aspect 19: The ganged connector apparatus of aspect 12, further comprising a spring device that operates to apply a spring force substantially in the direction of a front face of the CGA, wherein the spring force exerts a bias toward the CGCA in connection with the aligned state, and wherein the bias is exerted to at least one of the magnet or a threaded nut device.

Aspect 20: The ganged connector apparatus of aspect 19, wherein the spring device comprises a first leaf that exerts a first bias on the magnet and a second leaf that exerts a second bias on the threaded nut device.

Aspect 21: The ganged connector apparatus of aspect 20, wherein the second leaf contacts the threaded nut device, enabling clearance of an associated bolt that the threaded nut device is configured to receive.

Aspect 22: The ganged connector apparatus of aspect 12, wherein the alignment element is at least one of a T-member situated on a bottom side of the GCA, wherein the T-member is configured to constrain movement of the GCA within a slotted tray of a cabinet, and wherein the T-member is configured to enter a wide slot section of the slotted tray that is situated at a rear side of the cabinet, and be constrained, via the slotted tray, to movement that facilitates the aligned state when approaching a front side of the cabinet where the CGCA is to be mounted.

Aspect 23: The ganged connector apparatus of aspect 12, wherein the alignment element is at least one wing element situated on a side of the GCA, wherein the at least one wing element is configured to mate with an associated recess element of the CGCA, and wherein the at least one wing element extends beyond a front face plane of the GCA enabling contact with the associated recess element of the CGCA prior to achieving the aligned state and further enable granular constrained guidance to facilitate achieving the aligned state.

Aspect 24: The ganged connector apparatus of aspect 12, wherein the alignment element is at least one recess element situated on a side of the GCA, wherein the at least one recess element is configured to mate with an associated wing element of the CGCA, and wherein the at least one recess element is configured to receive the associated wing element of the CGCA prior to achieving the aligned state and to granularly guide contact with the CGCA to facilitate achieving the aligned state.

Aspect 25: The ganged connector apparatus of aspect 12, wherein the alignment element is at least one tenon element situated on and protruding from a front face of the GCA, and wherein the at least one tenon element is configured to mate with an associated mortise element of the CGCA prior to achieving the aligned state.

Aspect 26: The ganged connector apparatus of aspect 25, wherein the at least one tenon element operates as a bolt housing for a threaded bolt device configured to couple the GCA to the CGA.

Aspect 27: The ganged connector apparatus of aspect 12, wherein the alignment element is at least one mortise element accessible from a front face of the GCA, and wherein the at least one mortise element is configured to mate with an associated tenon element of the CGCA prior to achieving the aligned state.

Aspect 28: The ganged connector apparatus of aspect 27, wherein the at least one mortise element operates as a nut housing for a threaded nut device configured to couple the GCA to the CGA.

Aspect 29: A method, comprising: providing a ganged connector apparatus (GCA) comprising a magnet in a housing of the GCA; providing a corresponding ganged connector apparatus (CGCA) comprising a magnetically responsive material in a corresponding housing of the CGCA; positioning the GCA in proximity to the CGCA; magnetically coupling the GCA to the CGCA via a magnetic force exerted by the magnet on the magnetically responsive material, causing the GCA to enter an aligned state with respect to the CGCA; and applying a compression force to connect a group of connectors of the GCA to a corresponding group of connectors of the CGCA.

Aspect 30: The method of aspect 29, further comprising permitting the magnet to slide in an axial direction within a chamber of the housing of the GCA, thereby causing the magnet to protrude beyond a front face plane of the GCA prior to achieving an aligned state with the CGCA and to retract upon engagement.

Aspect 31: The method of aspect 29, further comprising biasing the magnet with a spring element that exerts a forward force on the magnet toward the CGCA.

Aspect 32: The method of aspect 29, further comprising biasing a threaded nut device with the spring element, causing the nut device to receive a threaded bolt from the CGCA during the aligned state.

Aspect 33: A method, comprising: providing a ganged connector apparatus (GCA) having at least one T-member on a bottom side of a housing of the GCA; providing a slotted tray in a cabinet, the slotted tray having a wide slot section at a rear side of the cabinet and a narrower slot extending toward a front side of the cabinet; inserting the T-member into the wide slot section from the rear side of the cabinet; sliding the GCA along the narrower slot to approach a corresponding ganged connector apparatus (CGCA) at the front side of the cabinet; and coupling the GCA to the CGCA after reaching an aligned state.

Aspect 34: The method of aspect 33, further comprising incorporating one or more keyed alignment elements that prevent an improper orientation of the GCA with respect to the CGCA during the sliding.

Aspect 35: A method, comprising: positioning a ganged connector apparatus (GCA), comprising first fiber ferrules that are individually covered by dust caps, in proximity to a corresponding ganged connector apparatus (CGCA) comprising second fiber ferrules configured to mate with the first fiber ferrules and which are individually covered by second dust caps; removing from at least one of the GCA or the CGCA, a multiple dust cap removal tool that was previously installed on the at least one of the GCA or the CGCA, wherein the multiple dust cap removal tool is configured to remove multiple ones of the first dust caps or the second dust caps substantially in unison, thereby reducing a ferrule exposure time before the GCA and the CGCA are coupled together.

Aspect 36: The method of aspect 35, further comprising placing the first dust caps on corresponding connectors of the GCA after cleaning the connectors.

Aspect 37: The method of aspect 35, further comprising positioning the multiple dust cap removal tool having slots configured to receive the first dust caps or the second dust caps, the slots comprising detents on sidewalls of the slots, wherein the detents are configured to facilitate removal of an associated dust cap.

Aspect 38: The method of aspect 35, further comprising installing the multiple dust cap removal tool by coaxing the first dust caps or the second dust caps into respective slots of the multiple dust cap removal tool such that a crown portion of the dust cap deforms and the detents engage a recess in a base portion of the dust cap.

Aspect 39: The method of aspect 35, further comprising, during an installation procedure to couple the GCA to the CGCA, delaying the removal of the dust caps until the GCA has been threaded through an interior region of the cabinet to reduce exposure to airborne dust prior to achieving an aligned state with a corresponding GCA.

Aspect 40: A method, comprising: securing a rail assembly to a frame of a data cabinet; mounting a ganged connector apparatus (GCA) on a sliding portion of the rail assembly; sliding the GCA from a retracted position in which the GCA is aligned with the frame to an extended position in which at least part of the GCA extends outwardly from the frame; and providing an expanded workspace for installing or servicing the GCA by maintaining the GCA in the extended position.

Aspect 41: A method, comprising: engaging a threaded nut device in a housing of a ganged connector apparatus (GCA) with a threaded bolt device of a corresponding ganged connector apparatus (CGCA) once the GCA and CGCA reach an aligned state; rotating the threaded bolt device while the GCA and CGCA remain magnetically coupled via a magnet in one of the housings; and generating a compression force sufficient to mate multiple fiber optic connectors of the GCA with corresponding connectors of the CGCA in unison.

Aspect 42: An apparatus, comprising: a patch panel retention insert configured to be inserted fixedly into one of two opposing lateral sides of an aperture of a patch panel, wherein the aperture is configured to host a first ganged connector module that is coupled to the patch panel, via the patch panel retention insert, from a front side and a second ganged connector module that is coupled to the patch panel, via the patch panel retention insert, from a rear side, the patch panel retention insert comprising: a first cantilevered tab that, in response to the first ganged connector module being seated in the aperture to be coupled to the second ganged connector module, locks the first ganged connector module to the patch panel; and a second cantilevered tab that, in response to the second ganged connector module being seated in the aperture to be coupled to the first ganged connector module, locks the second ganged connector module to the patch panel.

Aspect 43: The apparatus of aspect 42, wherein the patch panel retention insert is affixed to the patch panel via: a top post, situated at a top side of the patch panel retention insert, configured to mate with a top cutout of the patch panel; and a bottom post, situated at a bottom side of the patch panel retention insert, configured to mate with a bottom cutout of the patch panel.

Aspect 44: The apparatus of aspect 43, wherein the top post and the bottom post have distinct geometries that operate to at least one of prevent the top post from mating with the bottom cutout or prevent the bottom post from mating with the top cutout.

Aspect 45: The apparatus of aspect 42, wherein at least one of the first cantilevered tab or the second cantilevered tab is configured as snap-fit joint, and comprises at least one of: a first protrusion element that locks into place in response to engagement with a first recess element of a first associated ganged connector module; or a second recess element that locks into place in response to engagement with a second protrusion element of a second associated ganged connector module.

Aspect 46: The apparatus of aspect 42, wherein the first cantilevered tab is configured to unlock the first ganged connector module from the patch panel in response to a force applied to the first cantilevered tab in a lateral direction.

Aspect 47: The apparatus of aspect 42, wherein the second cantilevered tab is configured to unlock the second ganged connector module from the patch panel in response to a force applied to the second cantilevered tab in a lateral direction.

Aspect 48: The apparatus of aspect 42, wherein the first cantilevered tab and the second cantilevered tab are configured to independently lock and independently unlock an associated ganged connector module from the patch panel.

Aspect 49: The apparatus of aspect 42, wherein a first member of a group comprising the first cantilevered tab and the second cantilevered tab is configured to, in response to a force applied to the first member to release or unlock the first member, concurrently release or unlock a second member of the group that differs from the first member.

Aspect 50: A patch panel assembly, comprising: an aperture configured to receive a first ganged connector module from a front side of the patch panel assembly and a second ganged connector module from a rear side of the patch panel assembly; dual ganged connector brackets respectively positioned on opposing lateral sides of the aperture, the dual ganged connector brackets comprising: respective first cantilevered tabs that, in response to the first ganged connector module being seated in the aperture for coupling to the second ganged connector module, latch the first ganged connector module to the patch panel; and respective second cantilevered tabs that, in response to the second ganged connector module being seated in the aperture for coupling to the first ganged connector module, latch the second ganged connector module to the patch panel.

Aspect 51: The patch panel assembly of aspect 50, wherein at least one of a first cantilevered tab of the respective first cantilevered tabs or a second cantilevered tab of the respective second cantilevered tabs is configured as a snap-fit joint, and comprises at least one of: a first protrusion element that locks into place in response to engagement with a first recess element of a first associated ganged connector module; or a second recess element that locks into place in response to engagement with a second protrusion element of a second associated ganged connector module.

Aspect 52: The patch panel assembly of aspect 50, wherein at least one cantilevered tab of the respective first cantilevered tabs is configured to unlatch the first ganged connector module from the patch panel in response to a force applied to the at least one cantilevered tab in a lateral direction.

Aspect 53: The patch panel assembly of aspect 50, wherein at least one cantilevered tab of the respective second cantilevered tabs is configured to unlatch the second ganged connector module from the patch panel in response to a force applied to the at least one cantilevered tab in a lateral direction.

Aspect 54: The patch panel assembly of aspect 50, wherein the respective first cantilevered tabs and the respective second cantilevered tabs are configured to independently latch and independently unlatch an associated ganged connector module from the patch panel.

Aspect 55: The patch panel assembly of aspect 50, wherein a first member of a group comprising the respective first cantilevered tabs and the respective second cantilevered tabs is configured to concurrently release or unlock a second member of the group that differs from the first member in response to a force applied to the first member to release or unlock the first member.

Aspect 56: The patch panel assembly of aspect 50, wherein patch panel assembly is situated on a drawer slide device that allows the patch panel assembly to glide into and out of a data cabinet.

Aspect 57: The patch panel assembly of aspect 56, wherein the drawer slide device comprises a rear beam structure configured to support trunk cabling attached to the second ganged connector module, resulting in a mitigation of a shear force applied to the second ganged connector module.

Aspect 58: A method, comprising: inserting a first ganged connector module into a front side portion of an aperture of a patch panel assembly until the first ganged connector module engages with dual ganged connector brackets of the patch panel assembly; inserting a second ganged connector module into a rear side portion of the aperture until the second ganged connector module engages with the dual ganged connector brackets of the patch panel assembly; retaining the first ganged connector module and the second ganged connector module in respective seated positions via engagement with respective cantilevered tabs of the dual ganged connector brackets; and operating the patch panel assembly to facilitate data communication in a data communication environment with the first ganged connector module and the second ganged connector module being in a retained, coupled state.

Aspect 59: The method of aspect 58, further comprising unlocking the first ganged connector or the second ganged connector in response to application of at least one lateral force to at least one of the respective cantilevered tabs.

Aspect 60: The method of aspect 58, wherein the patch panel assembly is installed in a data cabinet via a drawer slide mechanism, and further comprising: extending the drawer slide to provide frontal access to the front side portion of the aperture or the rear side portion of the aperture.

Aspect 61: The method of aspect 60, further comprising: supporting a trunk cable attached to the second ganged connector module via a rear beam structure coupled to the drawer slide, thereby mitigating a shear force applied to the second ganged connector module.

Aspect 62: An apparatus, comprising: a patch panel retention insert configured to be inserted fixedly into one of two opposing lateral sides of an aperture of a patch panel, wherein the aperture is configured to host at least one ganged connector module that is coupled to the patch panel, via the patch panel retention insert, the patch panel retention insert comprising: a cantilevered tab that, in response to the at least one ganged connector module being seated in the aperture, locks the at least one ganged connector module to the patch panel.

What is claimed is:

1. A ganged connector apparatus (GCA), comprising:
a housing comprising a group of connectors that are individually configured to couple to a corresponding member of a corresponding group of connectors of a corresponding GCA (CGCA), the housing comprising an alignment element configured to facilitate an aligned state in which the GCA aligns with the CGCA prior to application of a compression force to connect the group of connectors to the corresponding group of connectors; and
a magnetic detent device comprising a magnet configured to magnetically couple, via a magnet force, the GCA to the CGCA prior to attaining the aligned state, wherein the magnetic force operates to aid in achieving the aligned state and to resist subsequent loss of the aligned state.

2. The ganged connector apparatus of claim 1, wherein the alignment element is further configured to be keyed or polarized to prevent misalignment resulting from an improper orientation of the GCA with respect to the CGCA.

3. The ganged connector apparatus of claim 1, wherein the aligned state results from individual members of the group of connectors of the GCA being aligned and in contact with an associated member of the corresponding group of connectors of the CGCA.

4. The ganged connector apparatus of claim 1, wherein the magnet is situated in a chamber configured to permit the magnet to slide in an axial direction that is substantially perpendicular to a front face of the CGA, resulting in the magnet being permitted to protrude beyond the front face of the CGA in order to make contact with the CGCA prior to reaching the aligned state, while being permitted to retract within the chamber in response to the aligned state being reached or in response to the compression force being applied.

5. The ganged connector apparatus of claim 1, further comprising a threaded nut device configured to mate with a threaded bolt device of the CGCA, thereby facilitating the application of the compression force to connect the group of connectors to the corresponding group of connectors.

6. The ganged connector apparatus of claim 5, wherein the threaded nut device is situated in a chamber configured to permit the threaded nut device to slide in an axial direction that is substantially perpendicular to a front face of the CGA to aid in achieving the aligned state regardless of a state of the threaded bolt device of the CGCA.

7. The ganged connector apparatus of claim 1, further comprising a spring device that operates to apply a spring force substantially in the direction of a front face of the CGA, wherein the spring force exerts a bias toward the CGCA in connection with the aligned state, and wherein the bias is exerted to at least one of the magnet or a threaded nut device.

8. A method, comprising:
positioning a ganged connector apparatus (GCA), comprising first fiber ferrules that are individually covered by dust caps, in proximity to a corresponding ganged connector apparatus (CGCA) comprising second fiber ferrules configured to mate with the first fiber ferrules and which are individually covered by second dust caps; and
removing from at least one of the GCA or the CGCA, a multiple dust cap removal tool that was previously installed on the at least one of the GCA or the CGCA, wherein the multiple dust cap removal tool is configured to remove multiple ones of the first dust caps or the second dust caps substantially in unison, as a result of which a ferrule exposure time is reduced before the GCA and the CGCA are coupled together.

9. The method of claim 8, further comprising placing the first dust caps on connectors of the GCA after cleaning the connectors.

10. The method of claim 8, further comprising positioning the multiple dust cap removal tool comprising slots configured to receive the first dust caps or the second dust caps, the slots comprising detents on sidewalls of the slots, wherein the detents are configured to facilitate removal of an associated dust cap.

11. The method of claim 8, further comprising installing the multiple dust cap removal tool by coaxing the first dust caps or the second dust caps into respective slots of the multiple dust cap removal tool, as a result of which a crown portion of the dust cap deforms and the detents engage a recess in a base portion of the dust cap.

12. The method of claim 8, further comprising, during an installation procedure to couple the GCA to the CGCA, delaying the removal of the dust caps until the GCA has been threaded through an interior region of the cabinet to reduce exposure to airborne dust prior to achieving an aligned state with a corresponding GCA.

13. An apparatus, comprising:
a patch panel retention insert configured to be inserted fixedly into one of two opposing lateral sides of an aperture of a patch panel, wherein the aperture is configured to host a first ganged connector module that is coupled to the patch panel, via the patch panel retention insert, from a front side and a second ganged connector module that is coupled to the patch panel, via the patch panel retention insert, from a rear side, the patch panel retention insert comprising:
a first cantilevered tab that, in response to the first ganged connector module being seated in the aperture to be coupled to the second ganged connector module, locks the first ganged connector module to the patch panel; and
a second cantilevered tab that, in response to the second ganged connector module being seated in the aperture to be coupled to the first ganged connector module, locks the second ganged connector module to the patch panel.

14. The apparatus of claim 13, wherein the patch panel retention insert is affixed to the patch panel via:
a top post, situated at a top side of the patch panel retention insert, configured to mate with a top cutout of the patch panel; and
a bottom post, situated at a bottom side of the patch panel retention insert, configured to mate with a bottom cutout of the patch panel.

15. The apparatus of claim 14, wherein the top post and the bottom post have distinct geometries that operate to at least one of prevent the top post from mating with the bottom cutout or prevent the bottom post from mating with the top cutout.

16. The apparatus of claim 13, wherein at least one of the first cantilevered tab or the second cantilevered tab is configured as a snap-fit joint, and comprises at least one of:
a first protrusion element that locks into place in response to engagement with a first recess element of a first associated ganged connector module; or
a second recess element that locks into place in response to engagement with a second protrusion element of a second associated ganged connector module.

17. The apparatus of claim 13, wherein the first cantilevered tab is configured to unlock the first ganged connector module from the patch panel in response to a force applied to the first cantilevered tab in a lateral direction.

18. The apparatus of claim 13, wherein the second cantilevered tab is configured to unlock the second ganged connector module from the patch panel in response to a force applied to the second cantilevered tab in a lateral direction.

19. The apparatus of claim 13, wherein the first cantilevered tab and the second cantilevered tab are configured to independently lock and independently unlock an associated ganged connector module from the patch panel.

20. The apparatus of claim 13, wherein a first member of a group comprising the first cantilevered tab and the second cantilevered tab is configured to, in response to a force applied to the first member to release or unlock the first member, concurrently release or unlock a second member of the group that differs from the first member.
